(19) United States
(12) Patent Application Publication
(10) Pub. No.: US 2018/0065896 A1
(43) Pub. Date: Mar. 8, 2018

(54) NITRIFYING MICRO-ORGANISMS FOR FERTILIZATION

(71) Applicant: IBEMA BIEZENMORTEL B.V., Biezenmortel (NL)

(72) Inventors: Martinus Adrianus Maria VAN IERSEL, Biezenmortel (NL); Wilhelmus Theodorus Antonius Maria DE LAAT, Biezenmortel (NL); Petrus Marinus Anna PARREN, Biezenmortel (NL); Valeska VAN BREUGEL, Biezenmortel (NL)

(73) Assignee: IBEMA BIEZENMORTEL B.V., Biezenmortel (NL)

(21) Appl. No.: 15/572,013

(22) PCT Filed: May 6, 2016
(86) PCT No.: PCT/NL2016/050329

§ 371 Date: Nov. 6, 2017

(30) Foreign Application Priority Data
May 7, 2015 (NL) 2014777

(51) Int. Cl. C05F 11/08

(52) U.S. Cl. CPC C05F 11/08

(57) ABSTRACT

The present invention relates to a microbial preparation enriched for and comprising a consortium of nitrifying micro-organisms comprising at least ammonium oxidizing micro-organisms chosen from bacteria of the group of Nitrosomonadaceae, comprising the genus Nitrosomonas, the genus Nitrosospira and the genus Nitrosovibrio, and/or from archaea of the group of Thaumarchaeota, of which bacteria and archaea at least two different species are present and at least nitrite oxidizing bacteria selected from the genera Nitrobacter and Nitrospira of which at least two different species are present. It further relates to a method for preparing such a microbiological preparation comprising the steps of a. Aerating an amount of compost in water; b. Extracting a sample of microorganisms from said aerated compost sludge; c. Culturing said microorganisms under aeration for several days and adding an ammonium compound at temp 10-35° C., preferably between 15 and 30° C., more preferably between 20 and 30° C.; d. Starting a new culture with an inoculation of the culture obtained from step c) or an inoculation obtained from a combination of culture obtained from steps c) and f), or c) and g with aeration at a rate that the dissolved oxygen concentration is kept at appropriate level, at temp 10-40° C., preferably between 15 and 30° C., more preferably between 20 and 30° C.; e. Adding nutrients and trace elements whenever needed during fermentation; f. Harvesting after sufficient time to reach a concentration of >10 nitrifying micro-organisms per ml g. Continuing feeding ammonia at reduced levels of ammonia of <00 ppm by harvesting and diluting with water to keep nitrate and nitrite concentrations in the culture at low levels not to inhibit conversions of ammonia to nitrite and nitrite to nitrate.; h. Optionally adding a fertilizer composition comprising protozoa, preferably compost; i. Optionally cooling the culture before further use or processing; and j. Optionally drying the culture before further use or processing.

### FIELD OF THE INVENTION

The present invention relates to the field of agriculture, or particular to compositions for fertilizing soil or other substrates that are used for growing of plants and crops. More particularly, the present invention relates to a consortium of nitrifying micro-organisms that can be used for such purposes.

### BACKGROUND

The growth of all organisms, especially plants, depends on the availability of mineral nutrients, and none is more important than nitrogen, which is required in large amounts as an essential component of proteins, nucleic acids, and other cellular constituents, including enzymes. Nitrogen is an essential constituent of chlorophyll, but it influences growth and utilization of sugars more than it influences photosynthesis through a reduction in chlorophyll. There is an abundant supply of nitrogen in the earth's atmosphere—nearly 79% in the form of N₂ gas. However, N₂ is unavailable for use by most organisms because the molecule is almost inert. In order for nitrogen to be used for growth it must be “fixed” (combined) in the form of ammonium (NH₄) or nitrate (NO₃) ions. The weathering of rocks releases these ions so slowly that it has a negligible effect on the availability of fixed nitrogen. Therefore, nitrogen is often the limiting factor for growth and biomass production in all environments where there is suitable climate and availability of water to support life. For this reason nitrogen is often supplied to a plant in the form of a fertilizer.

Nitrogen enters the plant largely through the roots. Microorganisms have a central role in almost all aspects of nitrogen availability, and therefore for life support on earth. Soil nitrogen exists in three general forms: organic nitrogen compounds, ammonium (NH₄⁺) ions and nitrate (NO₃⁻) ions. Most of the nitrogen (97-98%) in the soil is tied up in the organic matter and unavailable to plants. Only 2-3% is in the inorganic form of nitrate (NO₃⁻) and the ammonium (N₄⁺) forms that is available to plants. Organic matter (at proper moisture, temperature, and oxygen content) is continuously being broken down by microorganisms and released as inorganic nitrogen into the soil. This process is called mineralization. An opposite process also occurs where microorganisms feed on inorganic nitrogen. This process is called immobilization.

During the process of mineralization, most of the organic matter is first converted to ammonium (NH₄⁻). The process that converts the ammonium (NH₄⁺) to nitrate (NO₃⁻) by nitrifying micro-organisms is called nitrification. This process is very important because nitrate is readily available for use by crops and microorganisms. Nitrates are very mobile in the soil.

Nitrogen is lost from the soil in several ways: plant uptake, microorganisms, nitrates that move out with drainage water, and the loss of nitrates by denitrification. Denitrification occurs in flooded or saturated soils during periods of warm temperatures. In this state of depleted oxygen, microorganisms take oxygen from the nitrate (NO₃⁻). Then the nitrogen escapes into the air as gas. Denitrification is commonly observed in wet spots in corn fields where the plants are yellow and stunted.

Applied nitrogen (e.g. through fertilizers) can also be lost in several ways: urea applied to the surface converts rapidly to NH₃ and escapes into the air as ammonia gas when adequate moisture, temperature, and the enzyme urease is present. To avoid this loss the urea should, be incorporated immediately. An urease inhibitor can also be utilized to reduce loss.

Most plants absorb a majority of their nitrogen in the nitrate (NO₃⁻) form and to a lesser extent the ammonium (NH₄⁻) form. Some crops, such as rice, utilize ammonium as their primary source of nitrogen. Plant growth seems to improve when a combination of ammonium and nitrate nitrogen is taken up by the plant.

Most fertilizers comprise a substantial amount of nitrogen. This nitrogen in most cases, whether it is given as an individual compound or given in connection with other macronutrients such as phosphorus and potassium, is delivered in the form of ammonia or in the form of urea (CO(NH₂)₂). There is, however, a growing resistance against the use of these artificial, ‘chemical’ or ‘mineral’ fertilizers and especially for the organic grower market fertilizer compositions that are derived from nature (organic fertilizers, e.g. compost, manure or green waste) are taken.

When the crop's N supply comes exclusively from sources such as soil organic matter, cover crops, manure and composts, a thorough understanding of mineralization is essential to avoid a deficiency or surplus of available N. Mineralization is not consistent through the year and crop N demand should be matched with nutrient release from mineralization.

Mineralization rates are dependent on environmental factors (such as temperature and soil moisture), the properties of the organic material (such as C:N ratio, lignin content), and placement of the material.

Failure to synchronize N mineralization with crop uptake can lead to plant nutrient deficiencies, excessive soil N beyond the growing season, and the potential for excessive NO₃⁻ leaching. Examples of organic N containing fertilizers are composts, manure and cover crops.

Composts: Generally, composts contain relatively low concentrations of N and P. They typically decompose slowly and behave as a slow-release source of N over many months or years since the rapidly decomposable compounds have been previously degraded during the composting process. Composts can be made from on-farm materials, but they are also widely available from municipal and commercial sources. These composts vary in quality and tend to have low immediate nutritional value, but provide valuable sources of stable organic matter. Commercially composted manure is widely available from a variety of primary organic materials.

Manure: The chemical, physical, and biological properties of fresh manure vary tremendously due to specific animal feeding and manure management practices. The manure N is present in both organic and inorganic forms. Nitrogen is unstable in fresh manure because ammonia (NH₃) can be readily lost through volatilization. Application of fresh manure or slurry on the soil surface can result in volatilization losses as high as 50% of the total N in some situations. The combination of wet organic matter and NO₃⁻ in some manure can also facilitate significant denitrification losses. The organic N-containing compounds in manure become available for plant uptake following mineralization by soil microorganisms, while the inorganic N fraction is immediately available. Determining the correct application rate of manure and compost to supply adequate macronutrients during the growing season can be difficult. The amount of N that can be used will always be smaller than the total N in the manure since some loss occurs through volatilization with spreading, and only a portion of the organic N will be available to the plants during the growing season following application. The remaining organic N will slowly mineralize in later years. When manures and composts are applied at the rate to meet the N requirement of crops, the amount of P and K added is generally in excess of plant requirement. Over time, P can build up to concentrations that can pose an environmental risk since runoff from P-enriched fields can stimulate the growth of undesirable organisms in surface water. Excessive soil K can cause nutrient imbalances, especially in forages. The long-term use of P and K-enriched manures to provide the major source of N must be monitored to avoid these problems. Manures and composts can be challenging to uniformly apply to the field due to their bulky nature and inherent variability.

Application of raw manure may bring up concerns related to food safety, such as potential pathogens, hormones, and medications. The use of raw manure is restricted for some organic uses.

Cover Crops: A wide variety of plant species (most commonly grasses and legumes) are planted during the period between cash crops or in the inter-row space in orchards and vineyards. They can help reduce soil erosion, reduce soil NO₃⁻-leaching, and contribute organic matter and nutrients to subsequent crops after they decompose. Leguminous cover crops will also supply additional N through biological N₂ fixation. The amount of N contained in a cover crop depends on the plant species, the stage of growth, soil factors, and the effectiveness of the rhizobial association. Leguminous cover crops commonly contain between about 50 and about 200 kg N per hectare in their biomass. Cover crops require mineralization before N becomes plant available. The rate of N mineralization is determined by a variety of factors, including the composition of the crop (such as the C:N ratio and lignin content) and the environment (such as the soil temperature and moisture). As with other organic N sources, it can be a challenge to match the N mineralization from the cover crop to the nutritional requirement of the cash crop. It is sometimes necessary to add supplemental N to crops following cover crops to prevent temporary N deficiency.

Plants will generally prefer a mixture of ammonia and nitrate as nitrogen source for two main reasons. When ammonia is produced, the pH will increase in the root zone, which is very detrimental to the growth of the plant, while by nitrification in the root zone the pH will be kept in the optimal slightly acidic condition of about pH 6,4, which is optimal for uptake of minerals. Next to this, a large proportion of cations are needed for healthy plant growth, such as calcium, magnesium, potassium, boron, magnesium, zinc and iron. The uptake of these minerals is easier when a negatively charged nitrate molecule is used as nitrogen source in stead of a positively charged molecule, in order to keep a proper charge balance in the plant (Mulder, E. G., 1956, Mededelingen Directeur van de Tuinbouw 19(8/9): 673-690). For the above mentioned reasons, when growers can not and do not want to use chemical fertilizers like ammonium nitrate or calcium nitrate/potassium nitrate and the like, there is a need for biological nitrification in case the organic grower would want to produce food generally indicated as organic. Although nitrification activity is present in a healthy soil, it may get lost due to various reasons, such as severe weather conditions like heavy rain, heat and deep frost, but also due to use of pesticides, herbicides and fungicides, to anaerobic conditions due to heavy rain, compaction of the soil, bad draining properties of the soil, etc.

At present, an improvement in fertilization with respect to the availability of nitrogen, is still needed, especially in the field of organic agriculture.

### SUMMARY

The present inventors now have obtained surprisingly improved results by using a microbial preparation enriched for and comprising a consortium of nitrifying micro-organisms comprising at least two different species of ammonium oxidizing micro-organisms chosen from bacteria of the group of Nitrosomonadaceae, comprising the genus Nitrosomonas, the genus Nitrosospira and the genus Nitrosovibrio, and/or from archaea of the group of Thaumarchaeota, and at least two different species of nitrite oxidizing bacteria selected from the genera Nitrobacter and Nitrospira.

In a preferred embodiment the amount of bacteria of the genera Nitrosomonas, Nitrosospira and Nitrosovibro is at least 0.1% of the total number of microorganisms, preferably at least 0.5%, more preferably at least 1%, more preferably at least 8%, more preferably at least 17%, more preferably at least 31%, more preferably at least 36%. In a further preferred embodiment the amount of bacteria of the genera Nitrobacter and Nitrospira is at least 0.1% of the total number of microorganisms, preferably at least 0.4%, more preferably at least 3%, more preferably at least 11%, more preferably at least 16%, more preferably at least 28%, more preferably at least 36%. Further preferred is a microbial preparation, in which the total number of ammonium oxidizing archaea is at least 0.5% of the total number of micro-organisms, preferably at least 0.5%, more preferably at least 5.8%, more preferably at least 6.2%, more preferably at least 7.5% and more preferably at least 8.5%. Also preferred is such a composition in which the count of micro-organisms is at least 10⁵ micro-organisms per ml, preferably at least 10⁶ micro-organisms per ml, more preferably at least 10⁷ micro-organisms per ml, more preferably at least 10⁸ micro-organisms per ml, more preferably at least 10⁹ micro-organisms per ml, more preferably at least 10¹⁰ micro-organisms per ml, more preferably at least 10¹¹ micro-organisms per ml.

In a further preferred embodiment the bacteria from the genera Nitrosomonas, Nitrosospira and Nitrosovibrio comprise two or more of the species Nitrosomonas nitrosa, Nitrosomonas communis, Nitrosomonas europaea, Nitrosomonas eutropha, Nitrosomonas ureae, Nitrosomonas oligotropha, Nitrosomonas communis, Nitrosomonas vulgaris, Nitrosospira multiformis, Nitrosovibrio tenuis and unclassified Nitrosovibrio sp, whereas the bacteria from the genera Nitrobacter and Nitrospira comprise two or more of the species Nitrospira marina, Candidatus Nitrospira defluvii, Nitrospira moscoviensis, Nitrobacter winogradskyi, Nitrobacter vulgaris, Nitrobacter alkalicus, Nitrobacter hamburgensis and unclassified Nitrobacter sp. The group of Thaumarchaeota (also known under the name of Mesophilic Crenarchaeota) may comprise Candidatus Nitrosotalea, Nitrososphaera or Nitrosopumilus, such as Candidatus Nitrosotalea devanaterra, Nitrosopumilum maritimus, Nitrososphaera viennensis, and Candidatus Nitrososphaera gargensis. Also part of the invention is a microbiological preparation as described above, which is obtainable by a fermentation process, comprising the steps of

a. Aerating an amount of compost in water;

b. Extracting a sample of microorganisms from said aerated compost sludge;

c. Culturing said microorganisms under aeration for several days and adding an ammonium compound at temp 10-35° C. more preferably between 20 and 30° C.;

d. Starting a new culture with an inoculation of the culture obtained from step c) with aeration at a rate that the dissolved oxygen concentration is kept at appropriate level, at temp 10-35° C., preferably between 15 and 30° C., more preferably between 20 and 30° C.;

e. Adding nutrients and trace elements whenever needed during fermentation;

f. Harvesting after sufficient time to reach a concentration of >10⁵ nitrifying micro-organisms per ml; and optionally

g. Continuing feeding ammonia at reduced levels of ammonia of <500 ppm by harvesting and diluting with water to keep nitrate and nitrite concentrations in the culture at low levels not to inhibit conversions of ammonia to nitrite and nitrite to nitrate.

In a further preferred embodiment the preparation is available as liquid, a cooled liquid, as lyophilized powder, as spray-dried powder, as fluid-bed dried powder or as biofilm, etc.

Also preferred is an embodiment in which a microbial preparation according to the invention additionally comprises a fertilizer composition comprising protozoa, preferably compost or compost extract. Preferably the fertilizer composition comprises compost more preferably the commercially available compost extract such as Fytaforce™ Plant or Fytaforce™ Soil.

Further part of the invention is formed by a method for fertilizing a plant or a crop by adding a microbial preparation according to the invention. Preferably in such a method the microbial preparation is added to the substrate on which the plant or crop is grown, preferably wherein said substrate is soil, humus, peat, bark, perlite, vermiculite, pumice, gravel, fibers, such as wood, coco and hemp fibers, rice husks, brick shards, polystyrene packing peanuts, a hydroponic culture, and mixtures thereof regardless whether or not this substrate is normally or additionally fertilized with conventional and/or organic fertilizers and regardless whether the crop of plant is grown indoor or outdoor and regardless the time of the growing season in which the microbial preparation according to the invention is applied.

Also part of the invention is a method for preparing a substrate with improved fertilizing capabilities comprising adding a microbial preparation according to the invention to said substrate regardless whether or not this substrate is normality or additionally fertilized with conventional and/or organic fertilizers.

Further part of the invention is a method for preparing a microbial preparation according to the invention comprising the steps of

a. Aerating an amount of compost in water;

b. Extracting a sample of microorganisms from said aerated compost sludge;

c. Culturing said microorganisms under aeration for several days and adding an ammonium compound at temp 10-35° C., preferably between 15 and 30° C., more preferably between 20 and 30° C.;

d. Starting a new culture with an inoculation of the culture obtained from step c) with aeration at a rate that the dissolved oxygen concentration is kept at appropriate level, at temp 10-40° C., preferably between 15 and 30° C., more preferably between 20 and 30° C.;

e. Adding nutrients and trace elements whenever needed during fermentation;

f. Harvesting after sufficient time to reach a concentration of >10⁵ nitrifying micro-organisms per ml

g. Continuing feeding ammonia at reduced levels of ammonia of <500 ppm by harvesting and diluting with water to keep nitrate and nitrite concentrations in the culture at low levels not to inhibit conversions of ammonia to nitrite and nitrite to nitrate;

h. Optionally adding a fertilizer composition comprising protozoa, preferably compost or compost extract; and

i. Optionally cooling the culture before further use or processing; and

j. Optionally drying

A preferred method is formed by a method wherein the pH varies, preferably by oscillation, between pH 4.0 and pH 8.0. Alternatively, a preferred method of the invention is a method, wherein two or more parallel cultures are started in step c) and/or step d) which are kept at a different pH, preferably wherein at least one culture is kept at an acidic pH and wherein at least one culture is kept at a alkaline pH, and wherein before step h) harvests from these cultures are combined in the microbial preparation.

Further part of the invention is the use of a microbial preparation according to the invention as fertilizer. Further, the microbial preparation according to the invention may be used as a biofilm on organic and chemical fertilizer compositions and on plant seeds and as a component of seed coatings. Also the biological preparation according to the invention may be used for soaking roots of plants before planting.

### LEGENDS TO THE FIGURES

FIG. 1. Enhanced nitrification of commercial organic and chemical fertilizers including feather/hair meal, urea and ammonium sulfate by nitrifying bio-ertilizer (NF) composition.

FIG. 2. Enhanced nitrification of organic fertilizer (DCM ECO Mix 4) by nitrifying bio-fertilizer (NF) and NF concentrate.

FIG. 3. Enhanced nitrification of an organic fertilizer (DCM ECO Mix 4) by NF, freeze-dried NF and fluid bed dried NF.

FIG. 4. Maximum likelihood tree showing representative sequences of each OTU and closely related described species retrieved from nitrifying bio-fertilizer samples.

FIG. 5. Relative abundance of ammonia-oxidizing bacteria (Nitrosomonas, Nitrosospira, Nitrosovibrio and unclassified Nitrosomonadaceae) and nitrite-oxidizing bacteria (Nitrobacter and Nitrospira) in nitrifying bio-fertilizer (NF) prepared according to example 1 and 2.

FIG. 6 Yield of fifteen crops after the application of nitrifying bio-fertilizer (NF) on three types of substrate with four types of organic fertilizer. Yield is calculated as percentage of the control that did not receive NF. Error bars indicate standard errors.

FIG. 7 Yield of five crops after the addition of nitrifying bio-fertilizer (NF) under early spring arable field conditions with three types of organic fertilizer. Yield is calculated as percentage of the control (which was not treated with NF). Grey bars, Oirschot sandy soil; white bars, Thorn sandy soil. Error bars indicate standard errors

FIG. 8 8 Grass biomass expressed as percentage of the control after application of nitrifying bio-fertilizer (NF). Yield is calculated as percentage of the dry weight of the control (which was not treated with NF). Error bars indicate standard errors.

FIG. 9 Yield of seven crops after the addition of nitrifying bio-fertilizer (NP) in sandy soil with chemical fertilizers. Yield is calculated as percentage of the control that did not receive NF. Error bars indicate standard errors.

FIG. 10 Yield after the addition of vitrifying bio-fertilizer (NE) and compost tea (Fytaforce, FF). Yield is calculated as percentage of the control that did not receive bio-fertilizers. Error bars indicate standard errors.

FIG. 11 Lettuce yield, after the addition of nitrifying bio-fertilizer (NF), nitrogen fixing Beijerinckia (N-fix) compost tea (Fytaforce, FF) and combinations thereof. Yield is calculated as percentage of the control that did not receive bio-fertilizers. Error bars indicate standard errors.

FIG. 12 Lettuce yield in time after the addition of nitrifying bio-fertilizer (NF) and compost tea (Fytaforce, FF) with three types of organic fertilizer Error bars indicate standard errors.

### DETAILED DESCRIPTION

Nitrifying micro-organisms are herein defined as those micro-organisms that are, individually or jointly, capable of converting ammonia or ammonium-ions into nitrate salts or nitrate-ions. Nitrifying micro-organisms are known for a long time and in principle can be divided into two categories: micro-organisms that are able to convert ammonia into nitrite (NO₂⁻), and micro-organisms that are capable of converting nitrite into nitrate. Examples of the first group are ammonium oxidizing bacteria such as Nitrosomonas, Nitrosospira and Nitrosovibrio and archaea from the group of Thaumarchaeota, which harbours genera like Nitrososphaera, Nitrostalea and Nitrosopumilus; an example of the second group is the bacterial genus Nitrobacter and the genus Nitrospira. Some species of Nitrospira are also capable of converting ammonium to nitrate.

Fertilization is herein defined as the process of enriching the soil or other material in which plants grow, which would enhance the growth of the plant by either or both providing more nutrients and therefore providing an increase in the dry weight of the plant or by speeding up the growth process.

Since most of the nitrogen in the soil or in commercial fertilizers is in the form of ammonia, and plants will generally prefer a mixture of ammonia and nitrate as nitrogen source, a conversion of the ammonia that is present in the substrate of the growing plants into nitrate is advantageous. Yet, thus far no practical solutions to provide micro-organisms or microbial compositions to provide for this conversion have been found commercially attractive. Factors that may play a role are the fact that nitrifying micro-organisms need aeration, that nitrifying micro-organisms often are overwhelmed by other micro-organisms present in the growth substrate or fertilizer, that nitrate quickly leaks from plant growth substrates, or that too little ammonia is present in the growth substrate. A further major reason for failure may be that in many cases pure bacterial cultures are used or compositions of only a few species. This is especially relevant through the knowledge that many bacterial species have a optimum pH range which is above pH 7, whereas in many case the soil or the substrate on which the plant is growing is in the acidic range. In order to be universally applicable, it is more advantageous to have a multiplicity of different microbial genera and species, especially comprising archaea, in the microbial preparation. This multiplicity of genera is not only beneficial since they provide a multitude of different micro-organisms that can be used for nitrification, but also it ensures that even in conditions which are not optimal for some of the nitrifying micro-organisms, nitrifying micro-organisms of other genera or species may take over the ammonium oxidizing and nitrite oxidizing function. Such a multiplicity of microbial genera and species can be obtained by enriching a naturally occurring source of nitrifying micro-organisms for these specific nitrifying micro-organisms.

As example for such natural sources nitrifying micro-organisms may be enriched from soil, but preferably from (organic) fertilizer, such as compost. A procedure for enrichment takes several days, as described below, and harvest of the microbial preparation can best be achieved after 4 to 40 days of a batch fermentation. Harvesting at this moment ensures that there is sufficient variety of nitrifying micro-organisms. Of course it will depend on the nature and source of the material which micro-organisms, and more particularly which nitrifying micro-organisms will end up in the final preparation. However, it is submitted that any fermentation process performed along the lines as described below will yield a sufficient amount of nitrifying micro-organisms, even if the number of bacteria and/or archaea in the source material is relatively low. If the count of nitrifying archaea and/or bacteria in the start material would be exceptionally low, the culturing may be facilitated by adding a previous batch of enriched nitrifying micro-organisms. Sea water, sludge derived from the beach or sewage effluent can also be used, since these are relatively rich in nitrifying bacteria.

A typical microbiological preparation enriched for nitrifying micro-organisms can be obtained by adding a relatively rich source of nitrifying micro-organisms (e.g. compost) to water and keep the temperature between 8-35° C., preferably between 22° C. and 30° C. In this source the amount of nitrifying archaea probably could be minimal, in the range of 0.2% of the total number of micro-organisms. Of these archaea, archaea belonging to the group of Thaumarchaeota only form a part. The pH of the solution should preferably not be kept at a constant value, but may be varied over the range of pH 4.0-8.0. Oxygen and ammonia are added in appropriate amounts, preferably the ammonium concentration is kept relatively low to minimize the nitrite concentration, so that all the nitrite that is formed can be converted by the nitrite oxidizing bacteria and no (toxic) nitrite is accumulated. In order to get rid of non-bacterial contaminations, such as fibers, stones and plant materials, from the original material, the culture may be filtered through a sieve with a mesh of <2 mm, preferably less than 250 μm, more preferably less than 75 μm. More than one filtration step may be applied, by first starting with a coarse filtration and later with an additional finer filtration. Further, the fermenter content may be concentrated by microfiltration with a pore size of 0.5 or 0.2 μm. In such a culture microbial concentrations of 10⁵, 10⁶, 10⁷, 10⁸ or 10⁹ per ml may be easily reached.

The fermented culture is preferably concentrated by flocculation, centrifugation or microfiltration to a density of at least 10⁷ micro-organisms per ml, preferably at least 10^{8,} preferably at least 10⁹, more preferably at least 10¹⁰ and possibly to at least 10¹¹ micro-organisms per ml. Such a concentration can be achieved by processing the fermented culture, but also by dialyzing the fermentation culture to get rid of the toxic nitrate and toxic nitrite (and also from the produced nitrate that may cause end-product inhibition of the bacterial conversion).

The harvested culture maybe applied directly, but preferably it is dried, e.g. through lyophilisation, spray-drying or fluid-bed drying.

The invention thus relates to a microbial preparation comprising ammonium oxidizing bacteria comprising at least bacteria of the group of Nitrosomonadaceae, comprising the genus Nitrosomonas, the genus Nitrosospira and the genus Nitrosovibrio, and/or from archaea of the group of Thaumarchaeota, of which bacteria and archaea at least two different species are present and at least bacteria selected from the genera Nitrobacter and Nitrospira of which at least two different species are present. Such a bacterial preparation can be harvested from the fermentation method as described above and generally contains at least 10⁵ bacteria per ml, preferably at least 10⁶ bacteria per ml, more preferably at least 10⁷ bacteria per ml, more preferably at least 10⁸ bacteria per ml, more preferably at least 10⁹ bacteria per ml, more preferably at least 10¹⁰ bacteria per ml, more preferably at least 10¹¹ bacteria per ml.

Of the total number of micro-organisms at least 0.1% is of the bacterial genera Nitrosomonas, Nitrosospira and Nitrosovibro, preferably at least 0.5%, more preferably at least 1%, more preferably at least 8%, more preferably at least 17%, more preferably at least 31%, more preferably at least 36%. Further, in stead of or additional to the ammonium oxidizing bacteria, the culture may also contain ammonium oxidizing archaea, preferably from the group Thaumarchaeota. The total number of ammonium oxidizing archaea preferably is more than 0.05% of the total number of micro-organisms, more preferably more than 0.5%, more preferably more than 5.8%, more preferably more than 6.2%, more preferably more than 7.5% and more preferably more than 8.5%

Further, the amount of bacteria of the genera Nitrobacter and Nitrospira is at least 0.1% of the total number of microorganisms, preferably at least 0.4%, more preferably at least 3%, more preferably at least 11%, more preferably at least 16%, more preferably at least 28%, more preferably at least 36%. Although many species may be available for all of the genera of the nitrifying bacteria, it is preferred that the bacteria from the genera Nitrosomonas, Nitrosospira and Nitrosovibrio comprise two or more, preferably three or more, preferably four or more and more preferably all of the species Nitrosomonas nitrosa, Nitrosomonas communis, Nitrosomonas europaea, Nitrosomonas eutropha, Nitrosonzonas ureae, Nitrosomonas oligotropha, Nitrosomonas communis, Nitrosomonas vulgaris, Nitrosospira multiformis, Nitrosovibrio tenuis and unclassified Nitrosovibrio sp. Similarly, it is preferred that the group of archaea comprises organisms of one or more, preferably two or more species selected from the group of Thaumarchaeota (also known under the name of Mesophilic Crenarchaeota). Members of this group are Candidatus Nitrososphaera, Candidatus Nitrosotalea or Candidatus nitrosopumilus. These organisms may also be known under the genus names Nitrososphaera, Nitrosotalea or Nitrosopumilum. Preferred species are Nitrosotalea devanaterra, Nitrosopunzilunz maritimus and Nitrososphaera viennensis and Nitrososphaera gargensis. Similarly, it is preferred that the bacteria from the genera Nitrobacter and Nitrospira comprise two or more, preferably three or more, preferably four or more and more preferably all of the species Nitrospira marina, Candidatus Nitrospira defluvii, Nitrospira moscoviensis, Nitrobacter winogradskyi, Nitrobacter vulgaris, Nitrobacter alkalicus, Nitrobacter hamburgensis and unclassified Nitrobacter sp. As can be seen in the experimental part of the present invention, the microbial preparation contains a large number of micro-organisms, of which only a part are formed by the nitrifying micro-organisms. Further, many of the nitrifying micro-organisms were of a species that was not readily recognized at the species level by the assay that was used in the reported experiments. Nevertheless, there appear to be many more bacterial and archaeal species of the genera that have been mentioned above, which have not been specifically recognized in the experiments. Yet, these are classified as belonging to the genus of the nitrifying bacteria or archaea and thus should be considered to have ammonium and or nitrite oxidizing activity.

The microbial preparation can be used directly as an addition to the soil or other growth substrate or to a fertilizer composition. It can be used in both combination with an organic and with a chemical/mineral fertilizer. For this purpose the microbial preparation is preferable formulated as a liquid, as lyophilized powder, as spray-dried powder or fluid-bed dried powder. Preferably, the microbial preparation of the present invention is formulated in such a way that it can be readily sprayed over the area to which it should be applied. To enable spraying of the formulation the particle size of the particles in the formulation may not exceed 250 μm and preferably have a size of less than 150, preferably less than 75, more preferably less than 50 μm, more preferably less than 30 μm. For spraying the microbial preparation is preferably formulated as a liquid or a suspension. The aqueous solvent in which the micro-organisms are solved or suspended may be water or may be the culture broth that is directly derived from the fermentation. Alternatively, for storage or transport the harvest culture suspension may be cooled, preferably at a temperature of less than 10° C., more preferably less than 4° C., most preferably less than 2° C. under aerobic conditions.

The fermentation product may also be dried for storage. Usual preservative methods may be used for this, such as lyophilisation or spray-drying. Reconstitution of the stored microbial culture may be achieved by solving the stored powder in an aqueous solution.

Preferably in a method of producing a microbial preparation according to the invention the following steps are taken:

a. Aerating an amount of compost in water;

b. Extracting a sample of microorganisms from said aerated compost sludge;

c. Culturing said microorganisms under aeration for several days and adding an ammonium compound at temp 10-35° C.;

d. Starting a new culture with an inoculation of the culture obtained from step c), or an inoculation obtained from a combination of culture obtained from steps c) and f), or c) and g) with aeration at a rate that the dissolved oxygen concentration is kept at appropriate level, at temp 10-40° C., more preferably between 20 and 30° C.;

e. Adding nutrients and trace elements whenever needed during fermentation;

f. Harvesting after sufficient time to reach a concentration of >10⁵ nitrifying micro-organisms per ml

g. Continuing feeding ammonia at reduced levels of ammonia of <500 ppm by harvesting and diluting with water to keep nitrate and nitrite concentrations in the culture at low levels not to inhibit conversions of ammonia to nitrite and nitrite to nitrate.

h. Optionally adding a fertilizer composition comprising protozoa, preferably compost or a compost extract.

In the above method no requirements are set for a set pH value during one or more of the culturing steps. It has been found that many of the micro-organisms of which the presence is desired in the microbial preparation of the invention have pH preferences that are mutually exclusive. The pH preference of the Nitrosomonas bacteria lies in the range of pH 7-7.5, while the pH preference of most of the archaea lies in the acidic range (pH 4-7). Accordingly, if the culture is maintained under alkaline pH, it will favor the growth of the Nitrosomonas bacteria, but it will negatively affect the growth of the archaea. In contrast, a culture at a more acidic pH will stimulate growth of the archaea, but will hamper the growth of Nitrosomonas. Ideally, therefore, the pH of the culture should be oscillated, which can also be accomplished by batch wise addition of ammonia or ammonium containing compounds. Alternatively, sufficient biodiversity in the final microbial preparation can be obtained by performing multiple culturing methods, each at a different pH, and by mixing the harvest of these cultures into one final preparation. Ideally, at least two cultures will be kept, one at an acidic pH, and one at a alkaline pH.

In this method the compost is preferably a compost derived from organic waste, such as green waste, garden waste, kitchen waste, manure, and the like. It has been found that the compost that is used in the below described experiments has low numbers of nitrifying micro-organisms at the moment of the start of the culture. The number of Nitrosomonadae may be as low as 0.6%, while no bacteria of the genus Nitrosomonas are found. The amount of Nitrobacter might be as low as 0.1% and the total number of archaea is 0.2%, while there were no traceable amounts of members of the Thaumarchaeota group. The extracting of bacteria may he performed by an initial filtrating step as described above.

The ammonium compound that may be added may be ammonia, such as organic NH₃ from manure or gas-wastes of stables, but also ammonium containing compounds such as ammonium chloride, urea, ammonium sulfate, ammonium carbonate and ammonium phosphate and ammonia produced by protozoa and/or nematodes grazing on bacteria and fungi. The ammonium compound can also he used to regulate the pH of the culture. In step c) a first enrichment of the nitrifying micro-organisms is achieved. This is only enhanced in the following step in which an inoculum from the culture is taken to start a new culture. The amount of aeration is above 10%, preferably above 20%, but care should be taken not to fully aerate the culture. An upper limit of 80% aeration is preferred, and more preferred is an upper limit of 50% aeration. In this culture again ammonia anchor an ammonium compound as listed above is added, but at a rate-limiting amount, preferably less than 500 ppm, more preferably less than 400 ppm, more preferably less than 300 ppm, and most preferably less than 250 ppm, but concentrations may be as low as less than 50 ppm. Again here the ammonium compound can be added batch wise to obtain an oscillating during the culturing period. The fermentation culture should be maintained under these conditions for a period sufficient to reach a microbial cell count of at least 10⁶ cells per ml of which at least 10% are nitrifying micro-organisms. By performing a culture as described above such conditions can easily be reached after at least 10 days, or at least 12 days, or at least 15 days. Of course, to prevent depletion when a culture is maintained for a longer period, nutrients and trace elements should be added regularly or continuously, where the nutrients may comprise a carbon source, an ammonium compound and some sources of phosphorus and sulphur.

Care should be taken that the culture stays sufficiently diverse, in the sense that a multitude of bacterial and archaeal species, especially of the nitrifying micro-organisms are available. As indicated above, it is advisable to vary the culture conditions thereby preventing creating circumstances which are especially suitable for one type of bacterial or archaeal species and not to prolong the culture under steady conditions for more than 100 or, preferably not more than 75 days, more preferably not more than 60 days, more preferably not more than 50 days, since during the course of culturing opportunistic species tend to overgrow less competitive bacteria, thereby decreasing the biodiversity of the culture. As indicated above, this biodiversity is one of the major advantages of the current microbiological preparation.

Whereas the microbial preparation of the present invention may be used as such, e.g. to increase the nitrate availability in plant growth substrates that have been provided with organic or chemical fertilizers, it is preferably administered together with and/or additional to a fertilizer. Such a fertilizer may be a chemical fertilizer, but preferably it is a fertilizer that is compatible with organic farming, such as the fertilizers that have been mentioned in the background section of the present description: manure, cover crops and compost. Alternatively, an organic fertilizer which is rich in nitrogen sources, such as hair waste, feather waste, bone meal, (chicken) manure and Lucerne pellets may be used. Further, as is shown in the experimental section, it is even possible to add more than one fertilizer to the plant.

For the application of the microbial preparation to a plant, in one embodiment the microbial preparation is added to the plant substrate. The plant substrate, in this respect, may be any substrate that is suitable for culturing plants, such as soil (sand-based, silt-based, peat-based and clay-based soils), humus, peat, bark, perlite, vermiculite, pumice, gravel, fibers, such as wood-, coco- and hemp fibers, rice husks, brick shards, polystyrene packing peanuts, a hydroponic culture, and mixtures thereof, and the like. Most of these substrates, as the ones used in the experimental section, are commercially available. The bacterial preparation may be added to the substrate or it may be sprayed on the plant, e.g. on the leaves, stem or roots. Addition to the substrate is preferred.

In one embodiment of the present invention the bacterial preparation is mixed with a fertilizer, preferably a fertilizer that contains protozoa. Protozoa, as used herein, are defined as unicellular organisms comprising flagellates, amoebas and/or ciliates. Fertilizers comprising protozoa comprise composts, including worm castings. A preferred fertilizer composition to which the microbiological preparation may be added is a compost extract derived from compost (from organic waste), preferably one having more than 10⁴ protozoa, more preferably more than 10⁵ protozoa per ml. Such a compost extract is Fytaforce™ Plant or Fytaforce™ Soil (obtainable from Soiltech, Biezenmortel, The Netherlands). Addition of a composition comprising protozoa to the nitrifying microbial composition is advantageous, since the protozoa produce ammonia upon mineralization of organic nitrogen by fungi and bacteria, where the protozoa mineralize these microbes by grazing on bacteria and fungi (Clarholm et al., 1985, Soil Biol. Biochem. 17:181487; Bonkowski, M. et al., 2004, New Phytol. 162:617-631; Robinson et al., 1989, Plant and Soil 117:185-193; Kuikman et al., 1991, Soil Biol. Biochem. 23:193-200, Ronn et al., 2001, Pedobiologia 45:481-495). Protozoa (and also nematodes) that feed on bacteria and fungi will excrete ammonia, amines and amino acids as they have a much higher C/N ratio than protein rich bacteria. Because of this process the amount of nitrate that will be available for the plants will be higher than would be on the basis of the conversion of the originally available ammonium compound(s).

Application of this mix of the microbial preparation and the fertilizer is performed as with the unmixed preparation; preferably added to the substrate of the plant. Addition to the substrate can be covering the substrate with the mixed or unmixed microbial preparation, or the mixed or unmixed microbial preparation may be mixed more or less intensively with the substrate, e.g. by ploughing or raking the substrate with the microbial preparation of the invention.

The application of the microbial preparation of the present invention may have an effect on the size of the plant as compared to control plants, as is demonstrated in the experimental section, where the size of the plant is expressed as the fresh or dry weight. The application of the microbial preparation of the present invention may, however, also cause an increase in the speed of growth of the plant. Hence, use of a fertilization scheme as demonstrated in the experimental section may increase not only the harvest of crops, but also the turnover time for culturing the crop, thereby enabling more crop cycles in the same period of time.

The microbial preparation of the present invention, either used alone or in combination with a fertilizer may increase the yield of field or ornamental crops and/or it may reduce the cultivation time of a crop. In both cases there is an economic gain for the grower of the crop. The preparation is especially advantageous for increasing the yield of plants belonging to the families Solanaceae, Asteraceae, Fabaceae, Poaceae, Brassicaceae, Apiaceae, Amaranthaceae and Cucurbitaceae. The plants that are preferably treated with the microbial preparation are sweet pepper, tomato, potato, lettuce, chrysanthemum, sunflower, bean, pea, lupine, carrot, wheat, rice, rye, maize, savoy cabbage, Chinese cabbage, cauliflower, rapeseed, canola, celeriac, spinach, sugar beet, courgette, cucumber and grasses.

The preparation may be used under greenhouse conditions, under arable field conditions and even in hydroculture or other (soilless) cultivation systems.

It may be used during all seasons and with all sorts of temperature and climate conditions. From the experimental data it can be derived that it is extremely useful in early spring, low temperature conditions.

It may advantageously be used under conventional farming conditions, but it is compliant with organic farming conditions too and—as shown in the examples—it gives excellent results in combination with organic fertilizers.

Next to the application of the microbial preparation according to the invention as described above, the microbial preparation may also be used as a biofilm covering organic fertilizers. This may be seen as a special form of ‘mixing’ the microbial preparation and the fertilizer, but it forms a specific embodiment of the present invention, because it brings further advantages to the mixture. By having the nitrifying micro-organisms intermediate between the organic fertilizer and the substrate to which it will be added, the micro-organisms will be able to deplete the (possible toxic) ammonium source that is present in the substrate and also to profit from the ammonium production by the fertilizer as described above.

A further advantageous embodiment in which the microbial preparation according to the invention may be applied is to use the preparation for soaking planting material such as potato tubers or the roots of the plants before planting. Soaking the roots is a technique that is applied frequently in horticulture and by using the microbial preparation for soaking the plant root system will be provided with a collection of micro-organisms that can immediately deliver the necessary nitrogen source for nutrition. For this application even lower concentrations of the microbial preparation may be used (e.g. obtained by diluting the preparation with water).

Further, it may be used through mixing with the soil, in seed pellets and through spraying on the soil and/or plants. With respect to the application with seed, the microbial preparation of the invention may be used as a biofilm on seeds, or it may be used with other coating materials that are normally used for the coating of seeds, such as e.g. coatings that are used to form a seed pellet.

It has further been found that the microbial preparation of the current invention can be advantageously combined with the administration of nitrogen-fixing microorganisms. Nitrogen-fixing microorganisms are microorganisms, such as bacteria or archaea, which are able to transform atmospheric nitrogen into an inorganic chemical compound (most often ammonia), thereby bringing it into a form that may be used by plants. Two kinds of nitrogen-fixing bacteria are recognized: free-living (non-symbiotic) bacteria, including the cyanobacteria (or blue-green algae) Anabaena and Nostoc and genera such as Azotobacter, Beijerinckia, and Clostridium; and mutualistic (symbiotic) bacteria such as Rhizobium, associated with leguminous plants (e.g., various members of the pea family), Frankia and certain Azospirillum species, associated with cereal grasses

It will be clear that a combination of nitrogen fixation (provided by nitrogen fixing microorganisms) and conversion of ammonia into nitrate (provided by the microbial preparation of the invention in which both ammonium oxidizing and nitrite oxidizing microorganisms are present) is able to provide nitrate to the plants. And, as is shown in the experimental section, further addition of compost further increases the beneficial effect.

A further embodiment of the present invention is the application of the microbial preparation to increase the amount and/or concentration of N in a plant. This is especially useful when plants are being used as green manure. As is shown in the experimental part, an increase in the N content of plants is possible for the biomass obtained from pastures. Normally green manure is (in principle) only possible for plants that are known to fix nitrogen through the interaction with nitrogen fixing bacteria, such as legumes (interacting with Rhizobium). Because of the present inventions also plants that are not commonly known to be used as green manure (or only if mixed with known green manure plants) can be used for this purpose.

The dose of the microbial preparation that is to be applied to the plant will depend on the substrate of the plant, the fact whether or not compost or other fertilizer has been added to the microbial preparation and the climatologic circumstances, especially the humidity. In general it can be said that application of more than 0.02% of the microbial preparation of nitrifying micro-organisms (percentage calculated per total pot volume of 2.5l) already provides for an enhancement of the growth of the plant. An effective dose can also be expressed as the result of a culture of the nitrifying micro-organisms, where the culture provides a microbial cell count of about 10⁸ CFU/ml of which at least 10%, but preferably between 10 and 50% of the micro-organisms are nitrifying micro-organisms. It should be stated that the amount of archaea in the microbial preparation may be relatively low, while still being effective. The efficient ammonia oxidizing characteristics of archaea (see e.g. Martens-Habbema, W. et al., 2009, Nature, 461:976-981) allow that a low titer is already effective, especially when acting together with the nitrifying bacteria in the microbial preparation of the invention. As can be seen from the experimental section a nitrification effect can already been shown by applying 0.5 l of the microbial preparation (mixed with an equal amount of a fertilizer which comprises protozoa) on 1 m³ substrate. Increasing the dose may increase the stimulating effect, but care should be taken that when the amount of nitrifying micro-organisms is increased also an increase in ammonium as a nitrogen source for these micro-organisms should be available. This can be accomplished by mixing the sample of nitrifying micro-organisms with a fertilizer that comprises protozoa, such as compost. As can be seen from the below experiments, the combination of the microbiological preparation of the invention with a fertilizer comprising protozoa, such as compost or compost extract, increases the effect on the (speed of) growth of the plant. This effect can best be observed when the substrate is relatively poor: if the substrate already comprises compost, addition of compost extract to the nitrifying micro-organisms composition only seems to be beneficial at high doses.

It is further submitted that the skilled person, who can easily determine the constitution of micro-organisms that result from the culture (and especially the amounts of ammonium oxidizing archaea and ammonium oxidizing bacteria) can also easily determine which concentration of the microbiological preparation, optionally added to a further fertilizing composition, may yield the desired effect. Further, doses and conditions for applying the microbial preparation may be derived from the below examples. It is submitted that the skilled person will know or can easily find out for a specific crop and growth condition what the optimal dosage of the microbial preparation of the present invention should be.

For organic culturing activities the general hygiene and quality of the microbial preparation is important. The product obtained should have acceptable levels of mycotoxines, heavy metals and human pathogens. Therefore, it is advantageous to produce the microbial preparation according to the present invention under ISO22000 conditions, so these products can be used without the risk of outbreak diseases like EHEC or 0157:7 E. coli, Listeria monocytogenes, Salmonella, etc. The skilled person will know which measures should be taken to comply with the ISO 22000 standard.

The current invention is exemplified in the below experimental description. These are just examples and do not limit the above described invention in any way.

### EXAMPLES

Example 1 Culturing for enrichment of nitrifying bacteria and determining nitrification capacity

20 kg of compost (Van lersel Biezenmortel) was aerated for 30 minutes at ambient temperature in 60 Liter water. A sample of microorganisms from said aerated compost sludge was extracted by sieving through a 250 mu sieve and said microorganisms were cultured under aeration for several days while controlling temperature between 20 and 30° C., and pH between 6 and 7.5. Di-ammonium hydrogen phosphate was added at a concentration of 1.6 gr/L. Then a new culture was started by mixing 100 Liter water with 50 Liter of compost extract obtained from this culture with aeration while controlling temperature between 20 and 30° C., and pH between 6 and 7.5. Nutrients and trace elements were added whenever needed during fermentation.

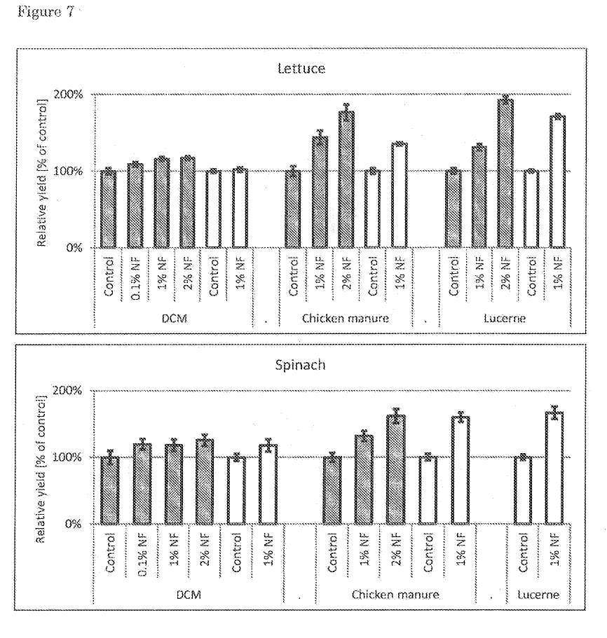

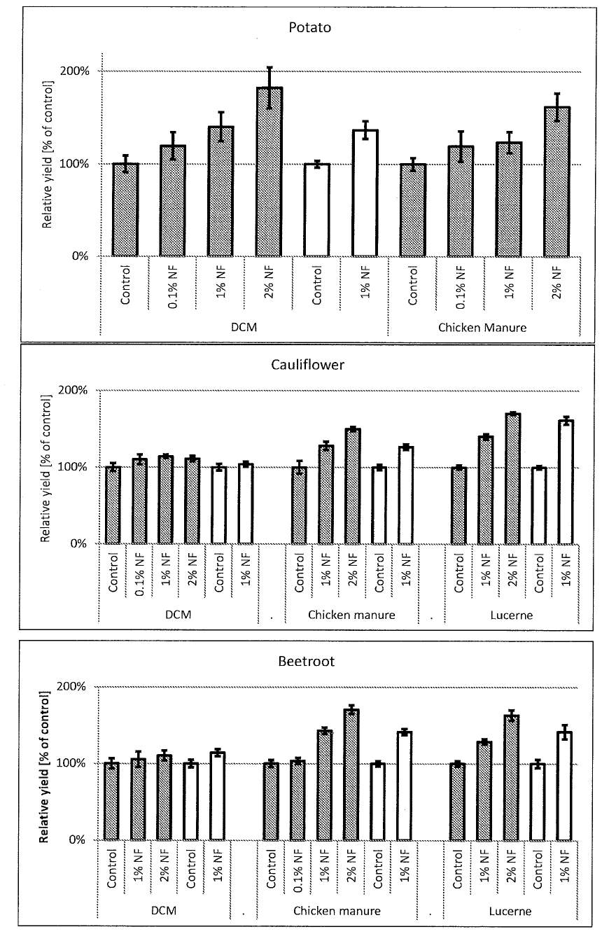

At the moment that the density of the culture reached about 1 to 5*10⁸ micro-organisms per ml it could be harvested. The culture was continued by feeding ammonia at reduced levels of ammonia of <500 ppm. From time to time the culture was harvested and diluted with water to keep nitrate and nitrite concentrations in the culture at low levels to prevent inhibition of conversions of ammonia to nitrite and nitrite to nitrate. In this way after more days of culturing the composition as depicted in FIG. 7 is obtained at a cell count of approximately 1 to 5*10⁸ per ml.

A sample of the nitrifying micro-organisms obtained by the above culturing method was mixed 1:1 with the commercially available compost extract composition Fytaforce™ Plant (Soiltech, Biezenmortel, The Netherlands) and applied in a nitrification test. Fytaforce™ Plant or Fytaforce™ Soil contains at least 4*10⁷ fungi and 5*10⁵ protozoa per ml.

Nitrification trials were performed on 10 L scale substrate mixtures comprising white peat 70%, black peat 30% with addition of 6 kg chalk and 0.1 kg PG Micromix (Yara Benelux, Vlaardingen, The Netherlands). Further added to this mix were 10 gram ammonium sulfate and various doses of the microbial preparation. Nitrate and pH were measured after 4 weeks of incubation at 22° C.

As can be seen from Table 1 the microbial preparation (as a mixture with Fytaforce Plant™) is by far more active in a peat mixture.

TABLE 1
Results of nitrate formation and pH after 4 weeks of
incubation of the various test mixtures on a peat substrate.

| | Nitrate | |
|---|---|---|
| Dosage | (ppm) | pH |
| Reference (ammonium sulfate only) | 22 | 5.8 |
| 100 L compost/m³ substrate | 52 | 5.7 |
| 1 L Fytaforce ™ Plant/m³ substrate | 30 | 5.6 |
| 2 L Fytaforce ™ Plant/m³ substrate | 32 | 5.6 |
| 5 L Fytaforce ™ Plant/m³ substrate | 35 | 5.5 |
| 0.5 L microbial preparation + 0.5 L Fytaforce ™ Plant/ | 70 | 5.3 |
| m³ substrate | | |
| 2.5 L microbial preparation + 2.5 L Fytaforce ™Plant/ | 165 | 5.0 |
| m³ substrate | | |
| 5 L microbial preparation + 5 L Fytaforce ™ Plant/ | 230 | 4.9 |
| m³ substrate | | |

Example 2: Concentrating nitrifying biofertilizer composition using microfiltration

In order to enhance the cell numbers of the Nitrifying bio-Fertilizer composition (NF) and to reduce the volume, concentrates were produced by microfiltration. Cell concentration and nitrifying activity of the concentrate were assessed.

NF was produced by aerating 20 kg of compost (Van Iersel, Biezenmortel) for 60 minutes at ambient temperature in 60 liters of water supplemented with di-ammonium hydrogen phosphate at a concentration of 1.6 gr/L. The aerated compost extract was sieved through a 250 μm sieve and incubated under aeration for several days at a temperature of 20-30° C., and pH between 5.8 and 7.5. A new incubation was started using 50 liters of this incubation, mixed with 50 liters of water and 50 liters of a previous batch of nitrifying bio fertilizer composition. This incubation was continuously aerated at a temperature of 24-30° C., and pH was controlled between 5.8 and 7.5. Nutrients, a source of ammonium, and trace elements were continuously added during fermentation. After approximately 2 weeks the nitrifying composition was concentrated by microfiltration.

Filtrate was concentrated by microfiltration using 0.2 μm hollow fiber cross-flow filter (WaterSep Investigator 12). Approximately 15 liters of prescreened NF was concentrated to a volume of 0.7 liters by recirculation over the crossflow membrane module. This resulted in a concentration factor of approximately 20×.

Cell numbers of ammonia oxidizing bacteria and archaea were assessed using qPCR targeting the ammonium monooxygenase gene (AMO). Primer pairs used for bacterial AMO were amoA-1F (5′-GGG GHT TYT ACT GGT GGT -3′) and amoA-2R (5′-CCC CTC KGS AAA GCC TTC TTC -3′), and for Archaeal AMO Arch-amoA-for (CTG AYT GGG CYT GGA CAT C) and Arch-amoA-rev (5′-TTC TTC TTT GTT GCC CAG TA -3′). Total bacterial cell numbers were determined with qPCR primers 338f (5′-ACT CCT ACG GGA GGC AGC AG-3′) and 518r (5′-ATT ACC GCG GCT GCT GG -3′).

Nitrifying activity was assessed using an oxygen consumption assay. 50 mL of NF sample was added to a temperature controlled mixing vessel. The oxygen concentration was monitored using an oxygen electrode fitted with a data logger. The vessel was aerated to achieve an oxygen concentration of >7 mg/L. Subsequently, aeration was stopped and oxygen consumption was measured to assess the endogenous oxygen consumption rate. Similarly, the ammonium oxidation rate was assessed by spiking the sample with ammonium and following oxygen consumption. The ammonium oxidation rate was corrected for endogenous respiration and expressed as nitrate production.

An overview of the results is provided in table 2. An increased cell number and an increase in nitrification activity corresponding to the concentration factor were observed. In conclusion: the results demonstrate that the NF solution can be effectively concentrated using microfiltration, increasing both the cell number and nitrification rate.

TABLE 2
Cell counts and nitrifying activity of concentrated and
unconcentrated NF.

| | Cell number | | | |
|---|---|---|---|---|
| | AMO | AMO | Total | Nitrification |
| | Bacteria | Archaea | bacteria | rate |
| Sample | cells/mL | cells/mL | cells/mL | mg NO3/L/h |
| NF 38 μm | 1.6 * 10⁷ | 4.7 * 10⁵ | 4.0 * 10⁷ | 34 |
| prescreened | | | | |
| NF concentrate | 2.8 * 10⁸ | 5.1 * 10⁶ | 9.7 * 10⁸ | 595 |
| Concentration | 17 | 11 | 24 | 18 |
| factor | | | | |

Example 3: enhanced nitrification of organic and chemical fertilizers in soil using concentrated, unconcentrated and dried bio-fertilizer compositions.

The effect of Nitrifying bio-Fertilizer composition (NF) on improved nitrification of organic and chemical fertilizers was tested using a soil based assay without crops. In addition a NF concentrate and dried NF compositions were tested

NF was produced according to example 2 and tested on the following commercial fertilizers: DCM ECO mix 4 (DCM Nederland B.V., Netherlands), Monterra Nitrogen 13 feather/hair meal (Vlamings, Netherlands), ammonium sulfate and urea. In addition an NF concentrate (100×) and freeze-dried and fluid bed dried NF compositions were produced. NF samples were concentrated by filtration prior to drying. For freeze-drying the concentrate was mixed with a cryoprotectant mixture containing skim milk, sucrose and glycerol and subsequently vacuum dried at a temperature of −60° C. For fluid bed drying two separate dried compositions were produced. For both compositions NF concentrates were produced. One concentrate was vacuum filtered and extruded to a 1 mm particle size. The other concentrate was mixed with vermiculite. Subsequently these composition were dried separately in a fluid bed dryer at 30° C.

The soil-based nitrification assays were performed using standard potting soil mixed with the individual fertilizers; ammonium sulfate (3.85 g/kg), urea (1.73 g/kg), DCM ECO mix 4 (11.6 g/kg)and feather/hair meal (6.27 g/kg). NF concentrate and unconcentrated NF were applied at 1% of the total pot volume. Water was used as a control. Pots were watered when needed to maintain moist conditions. Samples were taken in triplicate at different time intervals. Duplicate samples were used for freeze-dried NF samples and single samples were used for fluid-bed dried samples. Soil extracts were prepared by shaking with two volumes of demineralized water for 30 min and nitrate concentrations were determined with an ion selective electrode (Orion Versa Star, Thermo Scientific).

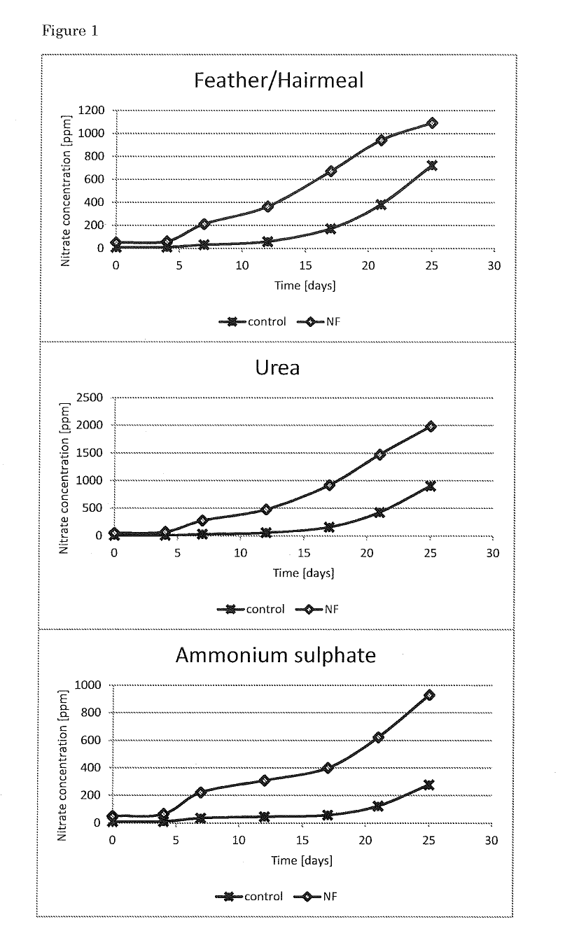

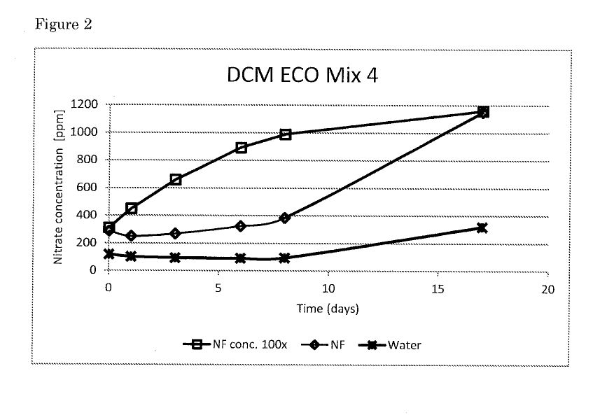

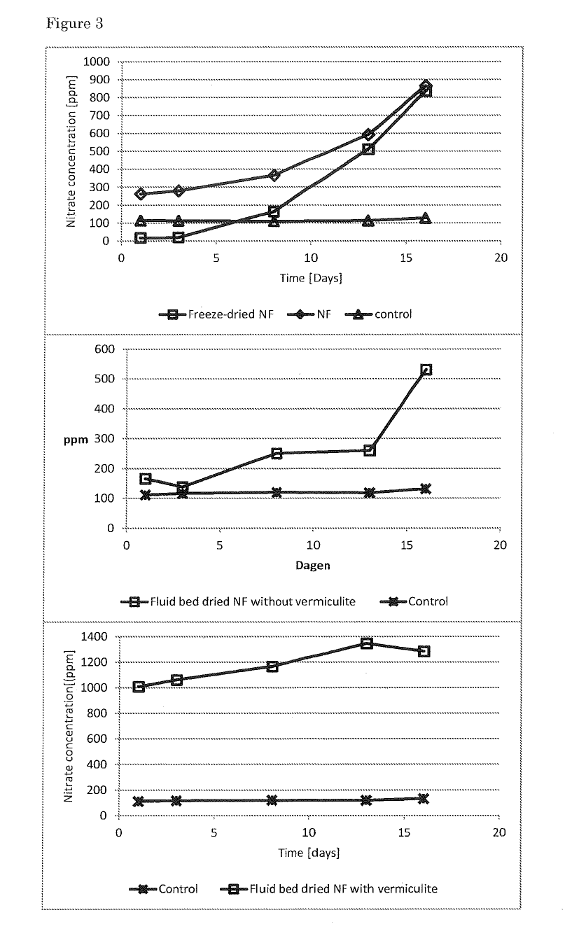

An overview of the results is provided in FIGS. 1, 2 and 3. In samples amended with unconcentrated NF nitrification was observed after 5 to 7 days. The control samples did not show any significant nitrification for periods of up to 15 days. The concentrated NF showed immediate nitrification plateauing after approximately 15 days. Both freeze-dried and fluid bed dried NF showed enhanced nitrification compared to the control

In conclusion: these results demonstrate that NF, NF concentrate and freeze-dried NF enhance the conversion of ammonium to nitrate for both organic and chemical fertilizers.

Example 4: Microbial community composition of nitrifying bio-fertilizer solution

The microbial community composition in different batches of nitrifying bio-fertilizer (NF) was followed for over one year.

Two samples, taken on 24 Dec. 2014 and on 5 Jan. 2015, were prepared according to Example 1 (E1-group). Five other samples, prepared according to Example 2, were taken on 13 Apr. 2015, 15 Jun. 2015, 4 Nov. 2016, 9 Feb. 2016, and 23 Feb. 2016 (E2-group), where sample NF 13 Apr. 2015 was the first sample that was used to transfer end-product NF to the next starting culture. DNA was extracted from 1 ml NF, using NucleoSpin® Soil kit (Macherey-Nagel, Duren, Germany) according to the manufacturer's instructions. Microbial communities were identified by Illumina MiSeq amplicon sequencing of the 16S rRNA V3-V4 region (BaseClear, Leiden, The Netherlands (E1-group); LGC Genomics, Berlin, Germany (E2-group)). Sequences were clustered into operational taxonomic units (OTUs) at 97% sequence identity cut-off, which is generally considered as the cut-off value to distinguish different microbial species. The E1-group samples were classified to species level or higher using the Greengenes database. E2-group samples were classified to genus level or higher with the SILVA database. Representative sequences of OTUs that belonged to the Nitrososphaera, Nitrosomonadaceae (Nitrosomonas, Nitrosospira, Nitrosovibrio), Nitrobacter and Nitrospira were further identified by blasting against the EzTaxon database (http://www.ezbiocloud.net/eztaxon). OTU level data were only available for E2-group samples. Sequences of OTUs and closely related described species were aligned and a maximum likelihood tree was created with MEGA6 (www.megasoftware.net).

NF appeared to contain a wide variety of microorganisms. Groups that were typically present were ammonia- and nitrite-oxidizing bacteria (see below), Thaumarcheota (6%; e.g. Nitrososphaera), Sphingobacteriales (6%; e.g. Chitinophagaceae, PHOS-HE51), Flavobacteriales (2%; e.g. Cryomorphaceae, Flavobacteriaceae), Bacilli (4%; e.g. Bacillus, Geobacillus, Paenibacillus, Rummeliibacillus), Phyllobacteriaceae (3%; e.g. Nitratireductor) and Xanthomonadaceae (2%; e.g. Lysobacter).

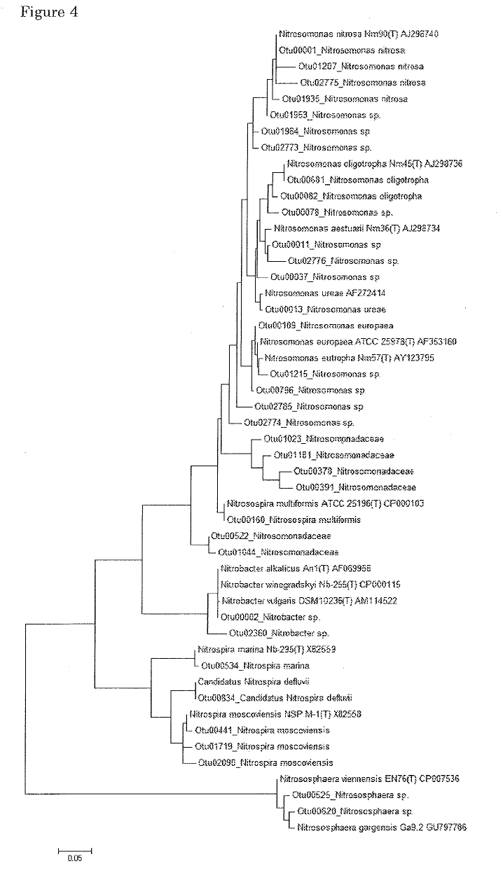

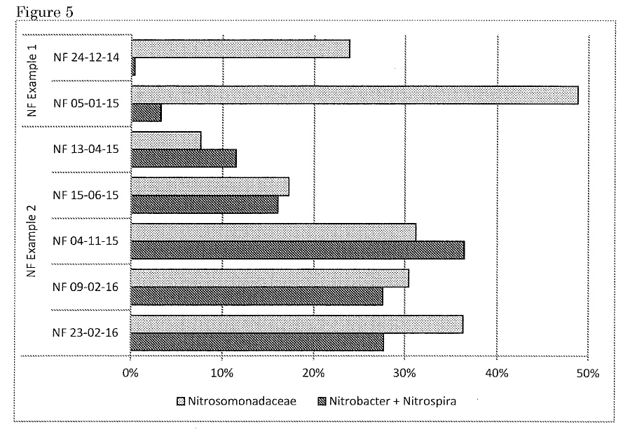

All ammonia-oxidizing bacteria belonged to the Nitrosomonadaceae family, these were Nitrosomonas nitrosa, Nitrosomonas ureae, Nitrosomonas europaea, Nitrosomonas oligotropha, Nitrosomonas communis, Nitrosomonas vulgaris, unclassified Nitrosomonas sp., Nitrosospira multiformis, unclassified Nitrosospira sp., Nitrosovibrio tennis, unclassified Nitrosovibrio sp. and unclassified Nitrosomonadaceae. Twenty-six OTUs were identified for the Nitrosomonadaceae. Two OTUs were found for the ammonia-oxidizing archaeal genus Nitrososphaera, belonging either to Nitrososphaera viennensis or Nitrosophaera gargensis. The nitrite-oxidizing bacteria belonged to Nitrobacter winogradskyi, Nitrobacter alkalicus, Nitrobacter hamburgensis, unclassified Nitrobacter sp., Nitrospira marina, Candidatus Nitrospira defluvi, Nitrospira moscoviensis or unclassified Nitrospira sp. and were represented by seven OTUs. A maximum likelihood tree of representative OTU sequences and their position compared to described species is given in FIG. 4.

FIG. 5 shows the relative abundance of ammonia-oxidizing bacteria and nitrite-oxidizing bacteria. Sample NF 13/04/15 was the first sample that was used to transfer end-product NF to the next starting culture according to the method described in Example 2. The following batches showed increased numbers of ammonia- and nitrite-oxidizing bacteria, leading to stable values around 30% for each group in the current product. The number of OTUs per sample varied between 10 and 14 for the ammonia oxidizers and 3 to 4 for the nitrite oxidizers (Table 2). The number of OTUs (created with a 97% sequence identity cut-off) gives a good indication for the number of species. However, some species have never been described, while others cannot be distinguished based on 16S rRNA sequences. Therefore, species names could only be assigned to a limited number of OTUs. Between 5 and 9 species of nitrifiers could be identified for each sample (Table 3). In conclusion, NF contains a wide variety of microbial species, with around 60% ammonia- and nitrite-oxidizing bacteria in NF prepared according to Example 2. Ammonia-oxidizing bacteria were represented by the Nitrosomonadaceae (Nitrosomonas, Nitrosospira, Nitrosovibrio) and nitrite-oxidizing bacteria by Nitrobacter and Nitrospira. Ammonia-oxidizing Archaea of the genus Nitrososphaera were also detected.

TABLE 3
Number of OTUs and identified species for ammonia-oxidizing bacteria (AOB) and
nitrite-oxidizing bacteria (NOB) in different NF batches.

| NF batch | # OTUs AOB | # OTUs NOB | Identified species |
|---|---|---|---|
| 24/12/14 | n.d. | n.d. | Nitrosomonas sp., N. nitrosa, N. europaea, N. communis, N. vulgaris, |
| | | | Nitrosospira sp., N. multiformis, Nitrosovibrio sp., |
| | | | N. tenuis, Nitrobacter sp., N. winogradskyi, N. alkalicus, N. hamburgensis, |
| | | | Nitrospira sp., Nitrososphaera sp. |
| 05/01/15 | n.d. | n.d. | Nitrosomonas sp., N. nitrosa, N. communis, N. vulgaris, |
| | | | Nitrosospira sp., Nitrosovibrio sp., Nitrobacter sp., N. winogradskyi, |
| | | | N. alkalicus, N. hamburgensis |
| 13/04/15 | 10 | 3 | Nitrosomonas sp., N. nitrosa, N. ureae, N. europaea, N. oligotropha, |
| | | | Nitrosospira multiformis, Nitrobacter sp., |
| | | | Nitrospira marina, N. defluvi |
| 15/06/15 | 10 | 3 | Nitrosomonas sp., N. nitrosa, N. ureae, N. europaea, |
| | | | Nitrosospira multiformis, Nitrobacter sp., Nitrospira defluvi, |
| | | | N. moscoviensis |
| 04/11/15 | 14 | 4 | Nitrosomonas sp., N. nitrosa, N. ureae, Nitrosospira |
| | | | multiformis, Nitrobacter sp., Nitrospira marina, N. moscoviensis, |
| | | | Nitrososphaera sp. |
| 09/02/16 | 14 | 3 | Nitrosomonas sp., N. nitrosa, N. ureae, N. oligotropha, |
| | | | Nitrosospira multiformis, Nitrobacter sp., Nitrospira marina, |
| | | | N. moscoviensis, Nitrososphaera sp. |
| 23/02/16 | 16 | 3 | Nitrosomonas sp., N. nitrosa, N. ureae, N. oligotropha, |
| | | | Nitrosospira multiformis, Nitrobacter sp., Nitrospira marina, |
| | | | Nitrososphaera sp. |

Example 5: Improved yields for a wide variety of crops by nitrifying bio-fertilizer solution in a range of substrates amended with organic fertilizers

The universal applicability of Nitrifying bio-Fertilizer solution (NF) was evaluated using a wide variety of crops representing the plant families Solanaceae, Asteraceae, Fabaceae, Poaceae, Brassicaceae, Apiaceae, Amaranthaceae and Cucurbitaceae.

Selected exemplary crop species were sweet pepper (Capsicum annuum), tomato (Solanum lycopersicum), lettuce (Lactuca Sativa), chrysanthemum, sunflower (Helianthus annuus), French bean (Phaseolus vulgaris), lupine (Lupinus luteus), wheat (Triticum aestivum), savoy cabbage (Brassica oleracea), chinese cabbage (Brassica pekinensis), cauliflower (Brassica olearacea var. botrytis), celeriac (Apium graveolens var. rapaceum), spinach (Spinacia olearacea), courgette (Cucurbita pepo) and cucumber (Cucumis sativus).

Bean, wheat, spinach and cauliflower were grown from seeds, the other crops were obtained as young plants. Plants were transferred to pots with standard potting soil, rich sandy soil or coco fibre. The substrates were pre-mixed with four types of organic fertilizer, DCM ECO mix 3 or 4 (4.2 or 3.0 g/liter), chicken manure (Fertisol Chicken Manure pellet, 5.3 g/liter), Lucerne (EKO Lucerne pellet, 7.1 g/liter) or feather/hair meal (Monterra Nitrogen 13; 1.6 g/liter).

NF was prepared as described in Example 2 and applied as a percentage of the total pot volume, either to the soil or directly on the seeds. Control treatments received an equal amount of water. Plants were grown in a greenhouse in the Netherlands and watered when needed to maintain moderate moist conditions. At harvest, the above ground fresh weight was determined and the relative yield as compared to the control was calculated.

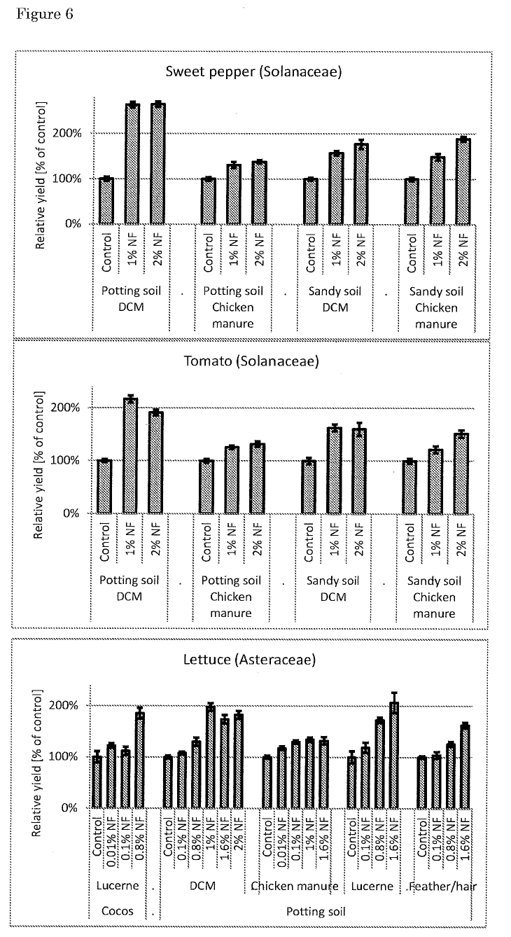

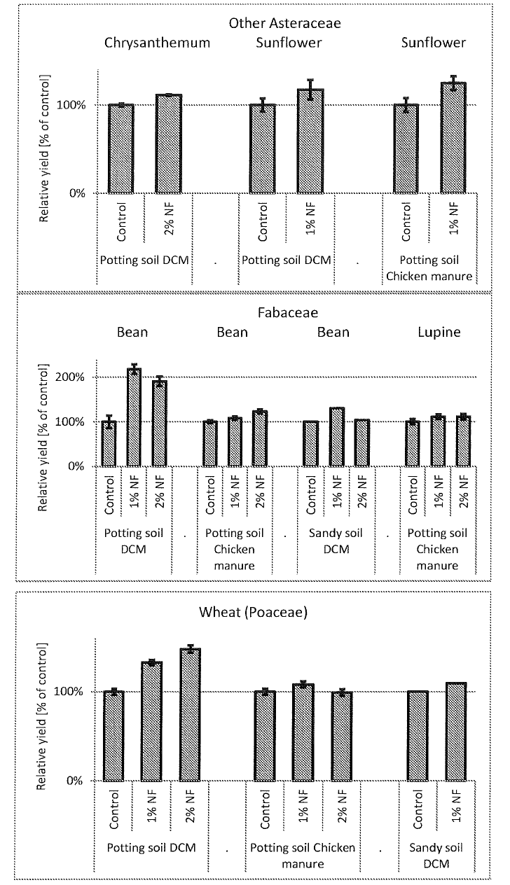

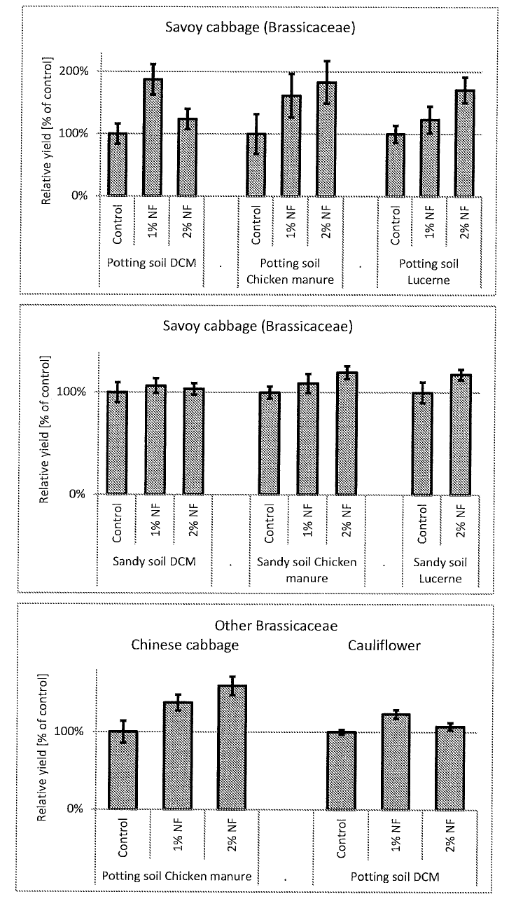

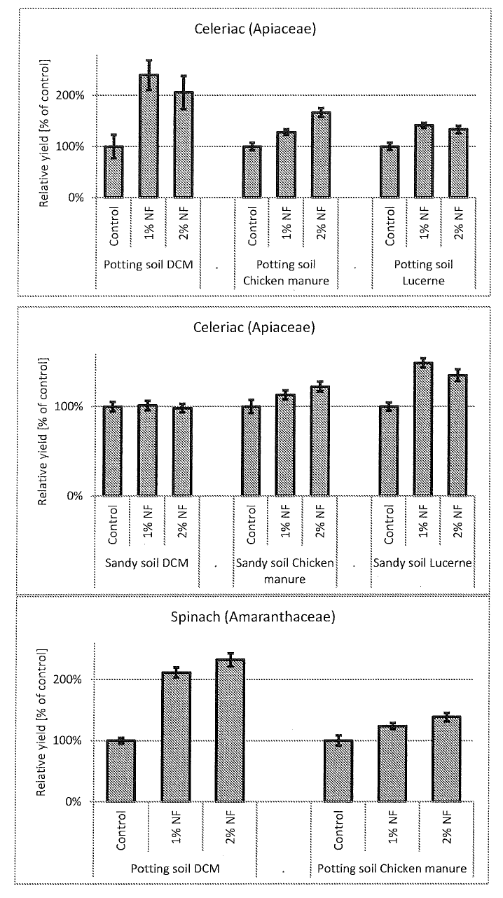

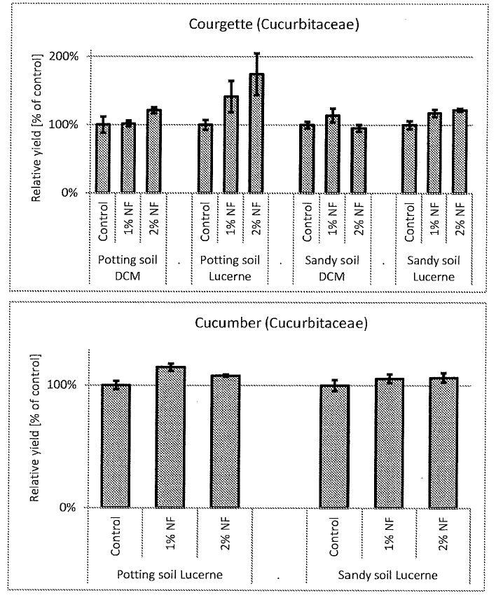

Yield increase by NF was observed for the following crops: sweet Pepper, tomato (Solanaceae), lettuce, chrysanthemum, sunflower (Asteraceae), French bean, lupine (Fabaceae), wheat (Poaceae), savoy cabbage, Chinese cabbage, cauliflower (Brassicaceae), celeriac (Apiaceae), spinach (Amaranthaceae), courgette and cucumber (Cucurbitaceae) (FIG. 6). Positive effects were found in potting soil, coco fibre and sandy soil, un-amended or amended with one of four organic fertilizer, DCM ECO mix, chicken manure, Lucerne or feather/hair meal. Yield was dependent on the specific crop-soil-fertilizer combination. For most crops 1% NF in potting soil with DCM ECO mix was very effective with doubled yields or more for sweet pepper (263%), tomato (217%), lettuce (198%), bean (218%), celeriac (240%) and spinach (211%).

In conclusion, NF can increase yield of a wide variety of plant families and crops. This was demonstrated using fifteen different crops on three types of substrates and four types of organic fertilizer, applied as soil or seed treatment. More than two-and-a-half times higher yields can be obtained.

Example 6: Positive effects of nitrifying bio-fertilizer solution on crop yield in early spring arable farming

The effect of Nitrifying bio-Fertilizer solution (NF) on crop yield was tested in sandy soil under low temperatures in order to evaluate the effect for early spring arable farming.

Crop species were lettuce (Lactuca Sativa), spinach (Spinacia olearacea), cauliflower (Brassica olearacea var. botrytis), beetroot (Beta vulgaris subsp. vulgaris var. ruba) and potato (Solanum tuberosum). Sandy soil was obtained from two fields, one with pH-H₂O 6.4, 17 ppm nitrate and 4.9 ppm ammonium (Oirschot, The Netherlands), the other with pH-H₂O 6.6, 25 ppm nitrate and 5.2 ppm ammonium (Thorn, The Netherlands).

Potato tubers, spinach seeds and young lettuce, cauliflower and beetroot plants were planted in pots with two different sandy soils, mixed with three types of organic fertilizer, DCM ECO mix 4 (3.0 g/liter), chicken manure (Fertisol Chicken Manure pellet, 5.3 g/liter) or Lucerne (EKO Lucerne pellet, 7.1 g/liter). NF was prepared as described in Example 2 and applied at 0.1%, 1% and 2% of the total pot volume, with 8-12 replicates per treatment. Water was included as a control. Plants were grown in an un-heated greenhouse in The Netherlands under low temperature conditions in order to mimic early spring outdoor temperatures. The average temperature was 9 to 10° C., with minimum temperatures around 4° C. and maximum temperatures around 14° C. Plants were watered when needed to maintain moderate moist conditions. At harvest, the above ground fresh weight was determined and the relative yield as compared to the control was calculated.

All five crops on two types of sandy soil with three types of organic fertilizer showed an increase in yield under the influence of NF (FIG. 7). Yields obtained under these conditions were up to 90% higher compared the control. In combination with DCM Eco mix, even a dosage of 0.1% NF could result in higher yields.

In conclusion, NF can increase yield under early spring arable farming conditions.

Example 7: Positive effects of nitrifying bio-fertilizer solution on grassland

The effect of Nitrifying bio-Fertilizer solution (NF) on the development of grassland (pasture)was tested.

Soil columns with 12.5 cm diameter were taken from grassland in The Netherlands. NF was prepared as described in Example 2 and applied at 100 liter per hectare with 8 replications. Water was included as a control. Columns were treated with NF and placed in an un-heated greenhouse in

The Netherlands and were placed outdoor during the days from the 10th of March till the 15^{th} of April 2016. At harvest, the above ground biomass was dried and weighed and the amount and concentration of N in the dry matter was measured

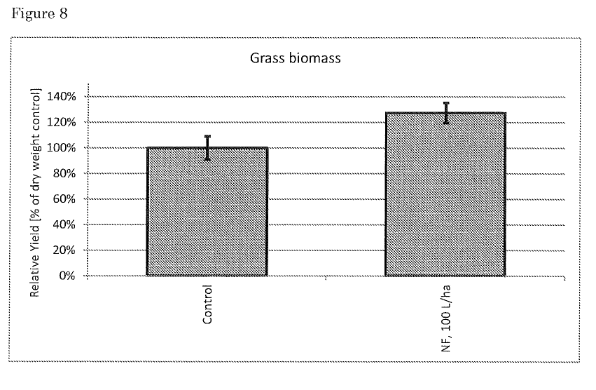

Grass biomass was higher after NF application. Biomass increased with 27% at 100 liter NF per hectare (FIG. 8), it contained 36% more nitrogen and showed a 7% higher concentration of N in its dry matter

In conclusion, NF can improve growth in grasslands and it can increase the N-content in the dry matter of grassland.

Example 8: Positive effects of nitrifying bio-fertilizer solution on crop yield in conventional farming

The effect of Nitrifying bio-Fertilizer solution (NF) on crop yield was tested under conventional fanning conditions in sandy soil, amended with chemical fertilizers.

Crop species were tomato (Solanum lycopersicum), lettuce (Lactuca Saliva), French bean (Phaseolus vulgaris), cauliflower (Brassica olearacea var. botrytis), celeriac (Apium graveolens var. rapaceum), carrot (Daucus carota subsp sativus) and sugar beet (Beta vulgaris subsp. vulgaris var. altissim). Bean, carrot and sugar beet seeds and young tomato, lettuce, cauliflower and celeriac plants were planted in pots with sandy soil, mixed with three types of fertilizer, NPK (Triferto NPK 12-10-18), calcium ammonium nitrate (CAN-27) or Urea-46, with amounts corresponding to half of the recommended N dose.

NF was prepared as described in Example 2. NF was applied in the following amounts per plant: 4, 10 and 20 nil (tomato, 8 replicates), 1, 3 and 10 ml (lettuce, 10 replicates), 0.03 and 3.3 ml (bean, 50 replicates), 0.25 and 10 ml (cauliflower, 10 replicates), 0.2, 2 and 10 ml (celeriac, 10 replicates), 0.12 ml (carrot, 50 replicates) and 1.25 and 3.75 ml (sugar beet, 50 replicates). Alternatively crops were sprayed with 100, 300 and 1,000 liter/ha (lettuce, 10 replicates), 30 and 100 liter/ha (bean, 50 replicates), 30 and 400 liter/ha (cauliflower, 10 replicates), 300 liter/ha (carrot, 50 replicates), 10 liter/ha (celeriac, 10 replicates) and 100 liter/ha (sugar beet, 50 replicates). Plants were grown in a greenhouse in the Netherlands and watered when needed to maintain moderate moist conditions. At harvest, the above ground fresh or dry weight was determined and the relative yield as compared to the control was calculated.

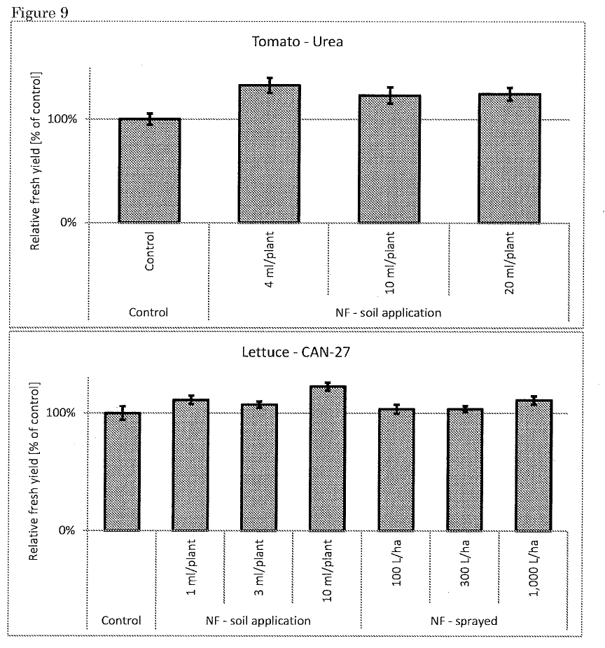

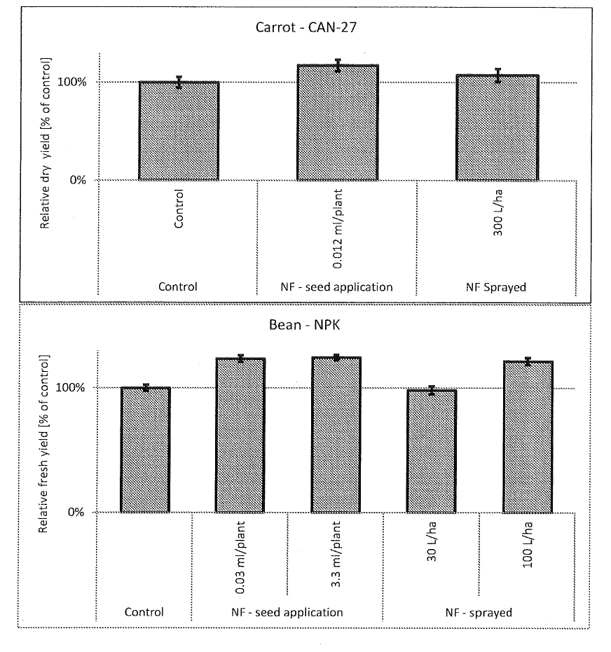

NF application in combination with chemical fertilizers resulted in significantly higher yields for tomato, lettuce, bean, cauliflower, carrot, celeriac and sugar beet. Yields increased up to a maximum of 33% (FIG. 9). The positive effects were observed for application in the soil, on the seeds or spraying on the soil surface.

In conclusion, NF can increase yield under conventional farming conditions. NF can either be applied as soil or seed treatment or sprayed after planting.

Example 9: The effect of nitrifying bio-fertilizer in combination with compost tea on crop yield

Complementary effects of compost tea and Nitrifying bio-Fertilizer solution (NF) were determined.

Pots with potting soil, mixed with organic fertilizers were prepared as described in Example 5 and planted with sweet pepper, savoy cabbage, French bean, wheat, cauliflower, chrysanthemum or lettuce. NF was prepared as described in Example 2 and Fytaforce compost tea (FF) was obtained from Soiltech (Fytaforce™ Plant; Biezenmortel, The Netherlands).

NF was applied as percentage of the total pot volume, with or without 0.2% FF. Plants were grown in a greenhouse in the Netherlands and watered when needed to maintain moderate moist conditions. At harvest, the above ground weight was determined and the relative yield as compared to the control was calculated.

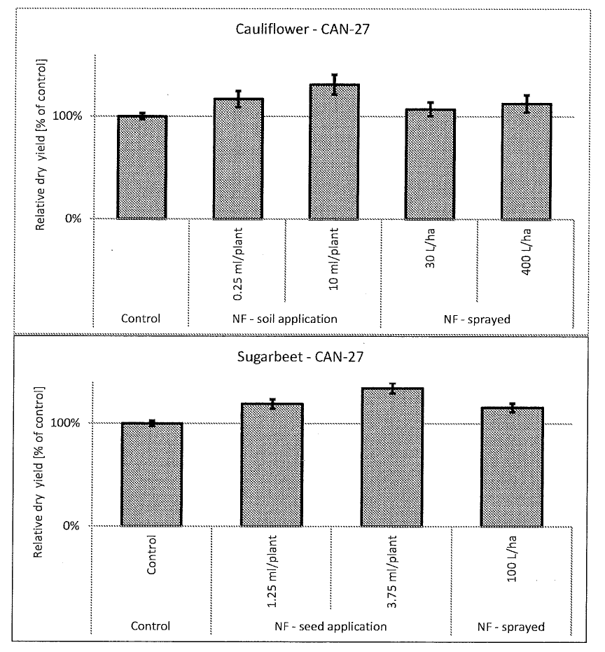

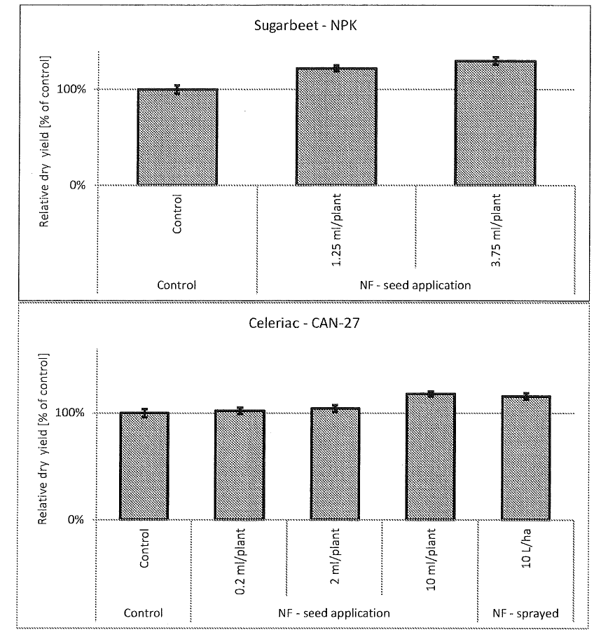

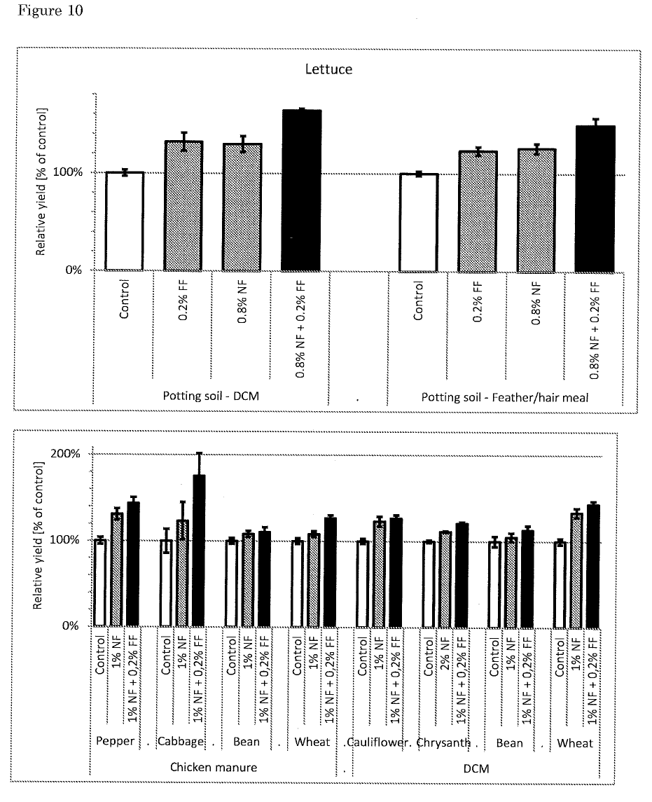

Treatment with NF resulted in increased yields. Combined application of NF with FF further increased yield for all crops (FIG. 10). In addition, it was demonstrated for lettuce that yield of the combined application was also higher than FF alone.

In conclusion, the combined application of NF and compost tea results in higher yields than NF or compost tea alone.

Example 10: The effect of nitrifying bio-fertilizer, nitrogen-fixing bio-fertilizer and compost tea on lettuce yield

Complementary effects of three types of bio-fertilizers, Nitrifying bio-Fertilizer solution (NF), nitrogen-fixing bacteria (N-fix) and compost tea (Fytaforce, FF), on lettuce yield were determined.

Young lettuce plants (Sala nova Cook) were planted in 2 liter pots, containing standard potting soil mixed with Guano (150 g phosphate per kg) and potassium carbonate (566 g potassium per kg). NF was prepared as described in Example 2 and Fytaforce compost tea (FF) was obtained from Soiltech (Fytaforce™ Plant; Biezenmortel, The Netherlands). The nitrogen fixer Beijerinckia derxii DSMZ2328 was used as the N-fix bio-fertilizer at a density of 10̂9 bacteria per ml. The three bio-fertilizers were applied to the soil, individually and in all possible combinations, 1.5 and 2.5 weeks after planting, with six replicates per treatment. Dosages were 0.2% of the total pot volume for NF and FF and 0.08% for N-fix. Plants were grown in an un-heated greenhouse in the Netherlands from 20 May till 25 Jun. 2015. Plants were watered when needed to maintain moderate moist conditions. At harvest, the above ground fresh weight was determined and the relative yield as compared to the control was calculated.

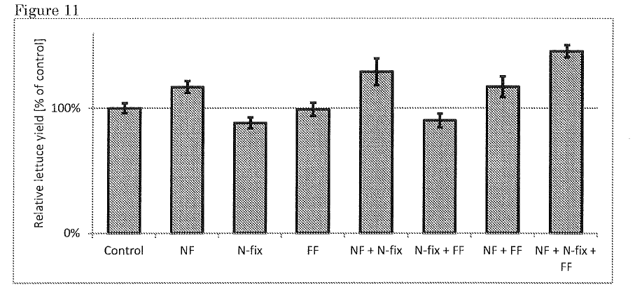

NF application resulted in a 17% higher lettuce yield, while N-fixers alone resulted in a biomass reduction. NF combined with N-fixers had a 46% higher yield than N-fixers alone and 29% more yield than the control Even higher yields were obtained with the combination of NF, N-fixers and compost tea. This triple application resulted in a 45% yield increase compared to the control (FIG. 11).

In conclusion, the combined application of the three bio-fertilizers NF, N-fixers and compost tea results in higher yields than the bio-fertilizers alone or in dual combinations.

Example 11: The effect of nitrifying bio-fertilizer solution on the development of lettuce in time

Lettuce was cultivated in standard potting soil with three types of organic fertilizers. Growth of the lettuce plants was followed in time after the addition of two bio-fertilizer solutions, Nitrifying bio-Fertilizer solution (NF) and compost tea (Fytaforce, FF).

Young lettuce plants (Salanova Cook) were planted in 2 liter pots, containing standard potting soil, mixed with either DCM ECO mix 1 (4 g/pot), Lucerne (EKO Lucerne pellet, 12 g/pot) or chicken manure (Fertisol Chicken Manure pellet, 9 g/pot). NF was prepared as described in Example 2 and Fytaforce compost tea (FF) was obtained from Soiltech (Fytaforce™ Plant; Biezenmortel, The Netherlands). At planting and two weeks later, bio-fertilizers were applied as percentage of the total pot volume in the following combinations: (1) control with water, (2) 0.5% NF, (3) 1% NF, (4) 2% NF, and (5) 1% NF +0.2% FF, with six replications per treatment. Plants were grown for 6 weeks in a greenhouse in the Netherlands from May till June 2015. Plants were watered when needed to maintain moderate moist conditions. At harvest after 21, 27, 33 and 45 days, the above ground crop was oven dried and weighed.

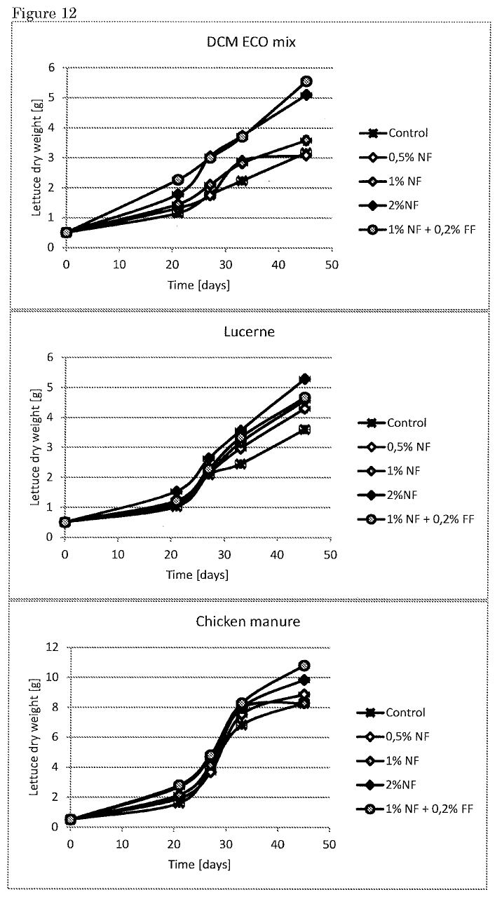

For DCM ECO mix and chicken manure, the 1% NF+0.2% FF treatment resulted in the highest yields (FIG. 12). Similar yields could be reached in less than ¼ of the cultivation time. After three weeks, lettuce with DCM ECO mix and 1% NF+0.2% FF reached yields that were double the yields of the plants that had not received bio-fertilizers. Lettuce yields with Lucerne fertilizer were about 1.5 times higher with 2% NF as compared to the control without bio-fertilizer (FIG. 12).

In conclusion, combined application of NF and compost tea can reduce cultivation time with more than 25%.

1-35. (canceled)

36. Microbial preparation enriched for and comprising a consortium of nitrifying micro-organisms comprising at least two different species of ammonium oxidizing micro-organisms chosen from
bacteria of the group of Nitrosomonadaceae, comprising the genus Nitrosomonas, the genus Nitrosospira and the genus Nitrosovibrio, preferably wherein the amount of bacteria of the genera Nitrosomonas, Nitrosospira and Nitrosovibro is at least 0.1% of the total number of microorganisms, preferably at least 0.5%, more preferably at least 1%, more preferably at least 8%, more preferably at least 17%, more preferably at least 31%, more preferably at least 36%, more preferably in which the bacteria from the genera Nitrosomonas, Nitrosospira and Nitrosovibrio comprise two or more of the species Nitrosomonas nitrosa, Nitrosomonas communis, Nitrosomonas europaea, Nitrosomonas eutropha, Nitrosomonas ureae, Nitrosomonas oligotropha, Nitrosomonas communis, Nitrosomonas vulgaris, Nitrosospira multiformis and Nitrosovibrio tenuis and unclassified Nitrosovibrio sp., and/or from
archaea of the group of Thaumarchaeota, preferably wherein the total number of ammonium oxidizing archaea is at least 0.05% of the total number of micro-organisms, preferably at least 0.5%, more preferably at least 5.8%, more preferably at least 6.2%, more preferably at least 7.5% and more preferably at least 8.5%., more preferably in which the archaea from the group of Thaumarchaeota (also known under the name of Mesophilic Crenarchaeota) comprise Candidatus Nitrosotalea, Nitrososphaera or Nitrosopumdus, such as Candidatus Nitrosotalea devanaterra, Nitrosopumilus maritimus, Nitrososphaera viennensis and Candidatus Nitrososphaera gargensis, and
at least two different species of nitrite oxidizing bacteria selected from the genera Nitrobacter and Nitrospira, preferably wherein the amount of bacteria of the genera Nitrobacter and Nitrospira is at least 0.1% of the total number of microorganisms, preferably at least 0.4%, more preferably at least 3%, more preferably at least 11%, more preferably at least 16%, more preferably at least 28%, more preferably at least 36%, more preferably in which the bacteria from the genera Nitrobacter and Nitrospira comprise two or more of the species Nitrospira marina, Candidatus Nitrospira defluvii, Nitrospira moscoviensis, Nitrobacter winogradskyi, Nitrobacter vulgaris, Nitrobacter alkalicus and Nitrobacter hamburgensis and unclassified Nitrobacter sp.

37. The microbial preparation of claim 36 in which the count of micro-organisms is at least 10⁵ micro-organisms per ml, preferably at least 10⁶ micro-organisms per ml, more preferably at least 10⁷ micro-organisms per ml, more preferably at least 10⁸ micro-organisms per ml, more preferably at least 10⁹ micro-organisms per ml, more preferably at least 10¹⁰ micro-organisms per ml, more preferably at least 10¹¹ micro-organisms per ml.

38. The microbial preparation of claim 36, which is obtainable by a fermentation process, comprising the steps of
a. Aerating an amount of compost in water;
b. Extracting a sample of microorganisms from said aerated compost sludge;
c. Culturing said microorganisms under aeration for several days and adding an ammonium compound at a temperature of 10-35° C. preferably between 20 and 30° C.;
d. Starting a new culture with an inoculation of the culture obtained from step c) or an inoculation obtained from a combination of culture obtained from steps c) and f), or c) and g) with aeration at a rate that the dissolved oxygen concentration is kept at appropriate level, at a temperature of 10-35° C., preferably between 15 and 30° C., more preferably between 20 and 30° C.;
e. Adding nutrients and trace elements whenever needed during fermentation;
f. Harvesting after sufficient time to reach a concentration of >10⁵ nitrifying micro-organisms per ml; and optionally
g. Continuing feeding ammonia at reduced levels of ammonia of <500 ppm by harvesting and diluting with water to keep nitrate and nitrite concentrations in the culture at low levels not to inhibit conversions of ammonia to nitrite and nitrite to nitrate.

39. The microbial preparation of claim 36 in which the preparation is available as liquid, a cooled liquid, as lyophilized powder, as spray-dried powder or granulate, as fluid-bed dried powder or granulate or as biofilm.

40. The microbial preparation of claim 36, additionally comprising a fertilizer composition comprising protozoa, preferably compost or compost extract, more preferably wherein the fertilizer composition comprises compost, more preferably the commercially available compost extract Fytaforce™ Plant or Fytaforce™ Soil.

41. Method for fertilizing a plant or a crop
or a method for increasing the nitrate availability in a plant substrate, wherein said soil has been provided with a chemical or organic fertilizer,
or a method for preparing a substrate with improved fertilizing capabilities, or a method for increasing the yield of fruits, vegetables, field crops and/or ornamental crops, preferably from the plant families Solanaceae, Asteraceae, Fabaceae, Poaceae, Brassicaceae, Apiaceae, Amaranthaceae and Cucurbitaceae,
or a method for increasing the yield of a plant selected from the group consisting essentially of sweet pepper, tomato, potato, lettuce, chrysanthemum, sunflower, bean, pea, lupine, carrot, wheat, rice, rye, maize, savoy cabbage, Chinese cabbage, cauliflower, rapeseed, canola, celeriac, spinach, sugar beet, beetroot, courgette and cucumber
wherein said method comprises the step of adding a microbial preparation according to claim 36 to said plant or crop, preferably wherein the microbial preparation is added to the substrate on which the plant or crop is grown, preferably wherein said substrate is soil, humus, peat, bark, perlite, vermiculite, pumice, gravel, fibers, such as wood, coco and hemp fibers, rice husks, brick shards, polystyrene packing peanuts, a hydroponic culture, and mixtures thereof.

42. The method of claim 41, wherein additionally nitrogen fixing microorganisms are added to the microbial preparation or wherein nitrogen fixing microorganisms are provided before, together with or after addition of the microbial preparation to said plant or crop.

43. The method of claim 41, wherein said method is performed under greenhouse conditions or under arable field conditions, preferably wherein said method is performed on a pasture or grassland.

44. The method of claim 41, wherein said method is exercised under organic farming conditions or under conventional farming conditions.

45. The method of claim 41, wherein said method causes an increase in crop yield or reduces the time until harvest.

46. The method of claim 41, wherein said method is exercised under early spring, low temperature conditions.

47. The method of claim 41, wherein adding the microbial preparation according to claim 1 is in the form of a biofilm on organic or chemical fertilizers or seeds or by soaking roots in before planting or by spraying said preparation on the soil or the plant or wherein said preparation is applied directly to the seed or as part of coating applied to the seed or in a seed pellet.

48. Method for preparing a microbial preparation of claim 36 comprising the steps of
a. Aerating an amount of compost in water;
b. Extracting a sample of microorganisms from said aerated compost sludge;
c. Culturing said microorganisms under aeration for several days and adding an ammonium compound at temp 10-35° C., preferably between 15 and 30° C., more preferably between 20 and 30° C.;
d. Starting a new culture with an inoculation of the culture obtained from step c) or an inoculation obtained from a combination of culture obtained from steps c) and f), or c) and g with aeration at a rate that the dissolved oxygen concentration is kept at appropriate level, at temp 10-40° C., preferably between 15 and 30° C., more preferably between 20 and 30° C.;
e. Adding nutrients and trace elements whenever needed during fermentation, preferably wherein the pH of the fermentation medium varies, preferably by oscillation, between pH 4.0 and pH 8.0;
f. Harvesting after sufficient time to reach a concentration of >10⁵ nitrifying micro-organisms per ml
g. Continuing feeding ammonia at reduced levels of ammonia of <500 ppm by harvesting and diluting with water to keep nitrate and nitrite concentrations in the culture at low levels not to inhibit conversions of ammonia to nitrite and nitrite to nitrate;
h. Optionally adding a fertilizer composition comprising protozoa, preferably compost;
i. Optionally cooling the culture before further use or processing; and
j. Optionally drying the culture before further use or processing.

49. Method according to claim 48, wherein two or more parallel cultures are started in step c) and/or step d) which are kept at a different pH, preferably wherein at least one culture is kept at an acidic pH and wherein at least one culture is kept at a alkaline pH, and wherein before step h) harvests from these cultures are combined in the microbial preparation.

50. Method of increasing the N content or concentration in a plant by providing said plant a microbial preparation of claim 36.

51. Plant with an increased content or concentration of N in comparison to an untreated plant obtained through a method according to claim 50.
